(19) United States
(12) Patent Application Publication
(10) Pub. No.: US 2023/0322259 A1
(43) Pub. Date: Oct. 12, 2023

(54) Inclusion And Use Of Safety and Confidence Information Associated With Objects In Autonomous Driving Maps

(71) Applicant: QUALCOMM Incorporated, San Diego, CA (US)

(72) Inventors: Ahmed Kamel SADEK, San Diego, CA (US); Alejandro Roberto VUKOTICH, München (DE); Jeremiah GOLSTON, San Diego, CA (US)

(21) Appl. No.: 17/658,126

(22) Filed: Apr. 6, 2022

(51) Int. Cl. B60W 60/00; G01C 21/00

(52) U.S. Cl. CPC B60W 60/0015; G01C 21/3807; G01C 21/3848; B60W 60/0053; B60W 2556/40; B60W 2556/25; B60W 2556/30

(57) ABSTRACT

Various embodiments include methods and systems for autonomous driving systems for using map data in performing an autonomous driving function. Various embodiments may include accessing map data regarding an object or feature in the vicinity of the vehicle, accessing confidence information associated with the map data, and using the confidence information in performing an autonomous or semi-autonomous driving action by the processor. The confidence information may be stored in the map database or in a separate data structure accessible by the processor. Methods of generating map safety and confidence information may include receiving information regarding a map object or feature including a measure of confidence in the information, using the received measure of confidence to generate safety and confidence information regarding the object or feature, and storing the safety and confidence information for access by vehicle autonomous and semi-autonomous driving systems.

### BACKGROUND

Advanced Driver Assistance Systems (ADAS) and Autonomous Driving Systems (ADS) can use digital maps as part of various operations, including route planning, navigation, collision and obstacle avoidance, and managing interactions with drivers. However, while an autonomous vehicle may receive information, perform path planning, and make maneuvering decisions based on sensor and map data, the ADS may only be informed about the accuracy, precision and other confidence information regarding vehicle sensor data, and thus may not be able to take into account accuracy, precision and similar confidence information regarding map data.

### SUMMARY

Various aspects include methods for including and using safety and/or confidence information regarding object and feature map data in autonomous and semi-autonomous driving operations. Various aspects may include methods performed by a processor of an autonomous driving system of a vehicle for using map data in performing an autonomous driving function, including accessing, from a map database accessible by the processor, map data regarding an object or feature in the vicinity of the vehicle, accessing, by the processor, confidence information associated with the map data regarding the object or feature in the vicinity of the vehicle, and using the confidence information by the processor in performing an autonomous or semi-autonomous driving action.

In some aspects, the confidence information may include one or more of: an Automotive Safety Integrity Level (ASIL) autonomous driving level in the vicinity of the object or feature, an indication related to accuracy of the map data regarding the object or feature, an indication related to reliability of the map data regarding the object or feature, a statistical score indicative of a precision of the map data regarding the object or feature, or an age or freshness of the map data regarding the object or feature.

In some aspects, accessing confidence information associated with the map data regarding the object or feature in the vicinity of the vehicle may include obtaining the confidence information by the processor from the map database, in which information in the map database is obtained from one or more of system memory, a remote computing device, or another vehicle. In some aspects, accessing confidence information associated with the map data regarding the object or feature in the vicinity of the vehicle may include obtaining the confidence information based on a location of the object or feature from a data structure accessible by the processor that is different from the map database.

In some aspects, using the confidence information in performing an autonomous or semi-autonomous driving action by the vehicle may include applying, by the processor, a weight to the accessed map data regarding the object or feature based upon the confidence information, and using weighted map data regarding the object or feature by the processor while performing a path planning, object avoidance or steering autonomous driving action. In some aspects, using the confidence information in performing an autonomous or semi-autonomous driving action by the vehicle may include changing an autonomous driving mode of the vehicle implemented by the processor based on the confidence information regarding the object or feature in the vicinity of the vehicle.

In some aspects, changing the autonomous driving mode of the vehicle implemented by the processor based on the confidence information regarding the object or feature in the vicinity of the vehicle may include changing the autonomous driving mode of the vehicle implemented by the processor to a driving mode compatible with the confidence information regarding the object or feature in the vicinity of the vehicle. Some aspects may further include notifying a driver of a need to participate in driving of the vehicle in response to determining that the confidence information regarding the object or feature in the vicinity of the vehicle does not support a fully autonomous driving mode, and changing the autonomous driving mode of the vehicle implemented by the processor after notifying the driver. In some aspects, the confidence information regarding the object or feature may include confidence information regarding objects and features within a defined area, and changing the autonomous driving mode of the vehicle implemented by the processor based on the confidence information regarding the object or feature in the vicinity of the vehicle may include changing the autonomous driving mode of the vehicle implemented by the processor to an autonomous driving mode consistent with the confidence information while the vehicle is in the defined area.

Some aspects may further include obtaining, by the processor from vehicle sensors, sensor data regarding the object or feature in the vicinity of the vehicle, determining, by the processor, whether the obtained sensor data regarding the object or feature in the vicinity of the vehicle differs from the map data regarding the object or feature obtained from the map database by a threshold amount, and uploading, by the processor to a remote computing device, the obtained sensor data regarding the object or feature in the vicinity of the vehicle along with confidence information based on one or more of a type of sensor used to detect or classify the object or feature, a quality of perception of the object or features achieved by the sensor, or an accuracy or precision of the sensor data in response to determining that the obtained sensor data differs from the map data regarding the object or feature obtained from the map database by at least the threshold amount.

Further aspects include a vehicle processing system including a memory and a processor configured to perform operations of any of the methods summarized above. Further aspects may include a vehicle processing system having various means for performing functions corresponding to any of the methods summarized above. Further aspects may include a non-transitory processor-readable storage medium having stored thereon processor-executable instructions configured to cause a processor of a vehicle processing system to perform various operations corresponding to any of the methods summarized above.

Further aspects include methods performed by a computing device for including safety and confidence information within map data useful by autonomous and semiautonomous driving systems in vehicles. Various aspects may include receiving, by the computing device from a source, information regarding an object or feature for inclusion in a map database including a measure of confidence in the information regarding the object or feature, using the received measure of confidence in the information regarding the object or feature to generate safety and confidence information regarding the object or feature suitable for use by vehicle autonomous and semi-autonomous driving systems in autonomous or semi-autonomous driving operations, in which the safety and confidence information may include one or more of an ASIL autonomous driving level in the vicinity of the object or feature, an indication related to accuracy of the map data regarding the object or feature, a statistical score indicative of a precision of the map data regarding the object or feature, an indication related to reliability of the map data regarding the object or feature, or an age or freshness of the map data regarding the object or feature, and storing the safety and confidence information regarding the object or feature in a manner that enables access by vehicle autonomous and semi-autonomous driving systems. In some aspects, storing the safety and confidence information may include updating information regarding the object or feature in the map database based at least in part on the received measure of confidence in the received information regarding the object or feature confidence.

In some aspects, receiving information regarding an object or feature for inclusion in a map database including a measure of confidence in the information regarding the object or feature may include receiving from one or more vehicles information including: a location of the object or feature, a characteristic of the object or feature, and a measure of confidence in the information regarding either the location or the characteristic of the object or feature.

In some aspects, storing the safety and confidence information regarding the object or feature may include including the safety and confidence information as part of location and other information regarding the object or feature in the map database provided to vehicles for use in autonomous or semi-autonomous driving operations. In some aspects, storing the safety and confidence information regarding the object or feature may include storing the safety and confidence information in a database separate from the map database correlated with location information of the object or feature, and providing the database to vehicles for use in autonomous or semi-autonomous driving operations.

In some aspects, receiving information regarding an object or feature for inclusion in a map database may include receiving, from a plurality of sources, information regarding the object or feature along with measures of confidence in the information regarding the object or feature. Such aspects may further determining, from information received from the plurality of sources, one set of information regarding the object or feature and consolidated safety and confidence information for the determined set of information regarding the object or feature, and storing safety and confidence information regarding the object or feature in a manner that enables access by vehicle autonomous and semi-autonomous driving systems for use in autonomous or semi-autonomous driving operations may include storing the consolidated safety and confidence information for the determined set of information regarding the object or feature in a manner that enables access by vehicle autonomous and semi-autonomous driving systems for use in autonomous or semi-autonomous driving operations.

Further aspects include a computing device, such as a server, including a memory and a processor configured to perform operations of any of the methods summarized above. Further aspects may include a computing device having means for performing functions corresponding to any of the methods summarized above. Further aspects may include a non-transitory processor-readable storage medium having stored thereon processor-executable instructions configured to cause a processor of a computing device to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing any of the various embodiments.

FIG. 2A is a component diagram of an example vehicle system suitable for implementing various embodiments.

FIG. 2B is a component block diagram illustrating computational layers of an example vehicle ADS processing system according to various embodiments.

FIG. 3A is a block diagram illustrating components of a system on chip for use in a vehicle ADS processing system in accordance with various embodiments.

FIG. 3B is a component block diagram illustrating a system configured to perform operations for using safety and/or confidence information related to objects and feature map data in accordance with various embodiments

FIGS. 4A and 4B are diagrams of street sections illustrating objects and features that may be included in a map database and about which safety and confidence information for use in accordance with various embodiments.

FIG. 4C is a data field diagram of data elements of a map database that includes safety and confidence information suitable for implementing some embodiments.

FIGS. 4D and 4E are data field diagrams of data elements of a map database and data elements of a safety and confidence information suitable for implementing some embodiments.

FIG. 5A is a process flow diagram of an example method 500a for using safety and/or confidence information related to objects and feature map data in accordance with various embodiments.

FIGS. 5B-5H are process flow diagrams of example operations 500b-500h that may be performed as part as described illustrated in FIG. 5A for using safety and/or confidence information related to objects and feature map data in accordance with some embodiments.

FIG. 6A is a process flow diagram of an example method executed by a computing device for generating a database of safety and/or confidence information based on information received from ADS-equipped vehicles in accordance with various embodiments.

FIGS. 6B-6E are process flow diagrams of example operations 600b-600e that may be performed as part of the method 600a illustrated in FIG. 6A for generating a database of safety and/or confidence information based on information received from ADS-equipped vehicles in accordance with some embodiments.

FIG. 7 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and processors of a vehicle autonomous driving system (ADS) for using map data that includes safety and/or confidence information in performing an autonomous driving function. Various embodiments may include the vehicle ADS processing system accessing a map database to obtain map data regarding an object or feature in the vicinity of the vehicle, and also accessing information regarding an autonomous driving safety level and/or information regarding a degree of confidence that should be ascribed to the corresponding map data regarding a given object or feature (referred to herein as “confidence information”). Such safety and/or confidence information may be included in or linked to the map data regarding the object or feature in the vicinity of the vehicle in a manner that enables the vehicle ADS processing system to obtain that information in conjunction with accessing or using the corresponding map data. Various embodiments may further include using the safety and/or confidence information by the processor in performing an autonomous or semi-autonomous driving action by the processor.

In some embodiments, the safety and/or confidence information may include an Automotive Safety Integrity Level (ASIL) autonomous driving level in the vicinity of the object or feature. Additionally or alternatively, in some embodiments the safety and/or confidence information may include an accuracy factor, metric or indication related to the object or feature map data. Additionally or alternatively, in some embodiments the safety and/or confidence information may include a reliability factor or metric. Additionally or alternatively, in some embodiments the safety and/or confidence information may include a statistical score indicative of a precision of the map data regarding the object or feature. Additionally or alternatively, in some embodiments the safety and/or confidence information may include an indication related to reliability of the object or feature map data. Additionally or alternatively, in some embodiments the safety and/or confidence information may include an age or freshness of the object or feature map data. For example, the vehicle ADS processing system may use safety information related to the object or feature map data to determine and implement an appropriate autonomous driving mode when in the vicinity of the object or feature. As another example, the vehicle ADS processing system may use confidence information to determine a weight to apply to the object or feature map data, and use weighted object or feature map data while performing a path planning, object avoidance or steering autonomous driving action. As another example, the safety and/or confidence information may include a statistical score or measure, such as an F-score or F-measure, which has a value between 1 (best) and 0 (worst) and provides a measure of a measurement's accuracy calculated from the precision of the measurements or sensor. An example of an F-score that may be used is known as an F₁ score, which is the harmonic mean of the precision. The F₁ score is also referred to as the Sorensen-Dice coefficient or Dice similarity coefficient.

In some embodiments, the safety and/or confidence information associated with the object or feature map data may be included within the map database so that the information can be obtained by the processor in the same or related operations as obtaining the object or feature information. For example, the safety and/or confidence information may be stored in one or more data fields along with position and description information regarding objects and features. In some embodiments, the safety and/or confidence information associated with the object or feature map data may be stored in and obtained from a data structure accessible by the processor that is different from the map database, such as a provisioned or downloaded (or downloadable) data table indexed to locations or an identifier of objects and features.

The map database and/or the safety and/or confidence information database may be stored in system memory and/or obtained from remote data stores, such as road side units, a central database server, and or other vehicles. The map information stored in a memory-hosted database may come from remote side units (e.g., a smart RSU) or from another vehicle. In such embodiments, the confidence assigned to objects and features in the map data may depend on the source of the map data. For example, the confidence level assigned to or associated with objects and features in a map generated from a single other vehicle received via V2X communications may be less than the confidence level assigned to or associated with objects and features in a map generated by map crowd sourcing.

In some embodiments, the vehicle ADS processing system may recognize when vehicle sensor data regarding an object or feature near the vehicle differs from map data by a threshold amount, and upload the sensor data to a remote computing device when that is the case. Such uploaded sensor data regarding the object or feature may include map coordinates along with information regarding a measure or estimate of the accuracy or precision of the sensor data. Some embodiments also include a remote computing device that may receive the object or feature sensor data, and use the received measure of confidence information regarding the object or feature confidence to generate safety and/or confidence information regarding the object or feature in a format (e.g., within a map database or separate database) suitable for use by a vehicle ADS in performing autonomous or semi-autonomous driving operations.

Various embodiments include storing or providing information regarding a safe ASIL (or other measure) autonomous driving level (referred to generally herein as “safety information” and/or information regarding a level of confidence (e.g., accuracy, precision, reliability, age, etc.) in object or feature map data. Safety information and confidence information may be related in some instances as it may be appropriate to indicate that fully autonomous driving is not safe in the vicinity of objects or features in which there is low confidence in the map data. However, safety information may be unrelated to confidence information, such as when map objects or features are associated with typical roadway, traffic or pedestrian conditions (i.e., in which there is high confidence in the map data) where full autonomous driving is risky. Also, there may be low confidence in map data for some objects or features without impacting safe autonomous driving levels, such as locations of objects or features alongside but not in the roadway. In various embodiments, safety information and information regarding the level of confidence in object or feature map data may be stored and accessed in the same or similar manners. For these reasons and for ease of reference, safety information and confidence information are referred to herein as “safety and/or confidence information” or collectively as “confidence information.” Thus, references to “confidence information” in the description and some claims is not intended to exclude information limited to safe autonomous driving levels.

As used herein, the term “vehicle” refers generally to any of an automobile, truck, bus, train, boat, and any other type of mobile ADS-capable system that may access map data to perform autonomous or semi-autonomous functions.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Technologies and technical standards are under development in multiple regions of the world for supporting evolving and future highway systems and vehicles, including setting standards for enabling safe autonomous and semi-autonomous vehicle operations. Such technologies include standardizing vehicle-based communication systems and functionality, and developing standards for vehicle autonomous driving systems (ADS).

Among standards being developed for autonomous and semi-autonomous vehicles is International Organization for Standardization (ISO) standard 26262 for the functional safety of road vehicles. ASIL is a risk classification defined by the ISO 26262 standard, which defines functional safety as “the absence of unreasonable risk due to hazards caused by malfunctioning behavior of electrical or electronic systems.” ISO 26262 defines Automotive Safety Integrity Levels (ASIL), which are risk classifications that are associated with appropriate levels of performance, accuracy and reliability imposed on vehicle ADS systems and data to ensure acceptable levels of functional safety in different autonomous driving modes. ASILs establish safety requirements—based on the probability and acceptability of harm—for automotive components to be compliant with the standard. There are four ASILs identified in ISO 26262—A, B, C, and D. ASIL-A represents the lowest degree and ASIL-D represents the highest degree of automotive hazard. Systems like airbags, anti-lock brakes, and power steering require an ASIL-D grade—the highest rigor applied to safety assurance—because the risks associated with their failure are the highest. On the other end of the safety spectrum, components like rear lights require only an ASIL-A grade. Head lights and brake lights generally would be ASIL-B while cruise control would generally be ASIL-C.

ASIL's are also referred to in terms of levels. Including a level of no functional safety equipment (“L0”), there are five ASILs. In L0 the driver is fully responsible for the safe operation of the vehicle and no driver assistance is provided. In L1 the driver can delegate steering or acceleration/braking, but the system performs just one driving task. In L2 the driver must constantly monitory the system, but the ADS performs several driving tasks (e.g., steering, cruise control with safe distance control, and automatic braking). In L3 the driver can turn attention away from the roadway in certain situations and the ADS can autonomously control the vehicle on defined routes (e.g., in highway driving). In L4 the driver can transfer complete control to the system but can take control at any time as the system is able to perform all driving tasks. Finally, in L5 no driver is needed as the system can control the vehicle autonomously under all conditions.

ASIL levels define not only the type of driving but also the level of confidence, accuracy and reliability required for a vehicle to operate at a given ASIL level of autonomy. Thus, when the safety and/or confidence information associated with map data of nearby objects or features is less than required for a vehicle's current ASIL level of operation (e.g., L4 or L5) or autonomous/semi-autonomous driving mode, the vehicle ADS processor should change the operating mode to an ASIL autonomous driving level consistent with the object/feature safety and/or safety and confidence information (e.g., L3). For example, if the vehicle is operating autonomously (e.g., in L4 or L5) and approaches objects and/or features with safety and/or safety and confidence information that only supports semi-autonomous or driver assistance operating modes (e.g., L3 or L2), the vehicle processor should notify the driver that he/she must pay attention to the roadway or take control of the vehicle. However, currently there are no agreed solutions for informing a vehicle ADS regarding the ASIL level associated with or appropriate for driving in the vicinity of particular objects or features identified in map data used by the ADS.

Among technologies and standards that will support autonomous and semi-autonomous driving are communication technologies and networks for Intelligent Highway Systems (ITS). Examples include standards being developed by the Institute of Electrical and Electronics Engineers (IEEE) and

Society of Automotive Engineers (SAE) for use in North America, or in the European Telecommunications Standards Institute (ETSI) and European Committee for Standardization (CEN) for use in Europe. For example, the IEEE 802.11p standard is the basis for the Dedicated Short Range Communication (DSRC) and ITS-G5 communication standards. IEEE 1609 is a higher layer standard based on IEEE 802.11p. The Cellular Vehicle-to-Everything (C-V2X) standard is a competing standard developed under the auspices of the 3rd Generation Partnership Project. These standards serve as the foundation for vehicle-based wireless communications, and may be used to support intelligent highways, autonomous and semi-autonomous vehicles, and improve the overall efficiency and safety of the highway transportation systems. ITS communications may be supported by next-generation 5G NR communication systems. These and other V2X wireless technologies may be used in various embodiments for downloading map data and safety and/or confidence information, as well as uploading observations by vehicle sensors for updating map data according to various embodiments.

The C-V2X protocol defines two transmission modes that, together, provide a 360° non-line-of-sight awareness and a higher level of predictability for enhanced road safety and autonomous driving. A first transmission mode includes direct C-V2X, which includes vehicle-to-vehicle (V2V), vehicle-to-infrastructure (V2I), and vehicle-to-pedestrian (V2P), and that provides enhanced communication range and reliability in the dedicated Intelligent Transportation System (ITS) 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation new radio wireless mobile communication technologies (5G NR systems, etc.), etc.

An autonomous vehicle may use map data in conjunction with vehicle sensors and other sources of information to perform autonomous and semi-autonomous functions, such as automatic braking and speed management, path planning, maneuvering, obstacle avoidance, etc. A vehicle ADS processing system typically receives information regarding the external environment (e.g., landmarks, road markings, traffic signs, etc.) as well as other vehicles from a plurality of onboard sensors (e.g., cameras, radar, lidar, Global Positioning System (GPS) receivers, etc.) that the processor can use for navigation and object avoidance. The vehicle processor may also use digital map data that includes locations and information regarding streets, roadway and near-road objects, roadway markings, traffic control signals, and other information useful for safely operating the vehicle autonomously or semi-autonomously. Examples of such digital maps include SD maps, information-rich high-definition (HD) maps, dynamic maps, and autonomous driving maps. The vehicle processor also may receive location information from a positioning system or a communication network.

Sensor data from various vehicle sensors used in performing autonomous and semi-autonomous functions will exhibit different levels of accuracy and precision. Sensors have inherent limitations on accuracy and precision depending on the nature and design of each sensor (e.g., sensor operational wavelength, aperture dimensions, position on the vehicle and field of view, etc.). Additionally, environmental conditions, such as precipitation, smoke, dust, illumination, sun angle, etc., can affect the accuracy and precision of sensor data. Thus, in performing autonomous and semi-autonomous functions the vehicle processor may take into account inherent and potential inaccuracies in sensor data, such as by consolidating data from multiple sensors to determine locations of the vehicle with respect to features and objects in the environment. In so doing, the processor may take into account a level of confidence associated with each sensor or set of sensor data, relying more heavily on sensor data with a high level of confidence than on sensor data having a lower level of confidence. For example, in consolidating data from multiple sensors for determining location, making steering or braking decisions and path planning, the processor may apply weights to various sensor data based on a confidence metric associated with each sensor to arrive at a weighted or confidence-adjusted location of various objects and features in the environment.

Similar to sensor data, the information regarding objects and features included in maps used by ADS-equipped vehicle processors may have varying levels of accuracy or precision depending on the sources of such information. For example, position information providing roadway boundaries (e.g., centerline of lanes, lane widths, curb locations, etc.) may be determined through a survey and thus recorded in the map with high accuracy and high confidence. Conversely, position information regarding landmarks and temporary obstacles (e.g., construction sites, moveable barriers, potholes, etc.) may be gathered by vehicle sensors that have varying degrees of accuracy and precision depending on characteristics of the sensors, the conditions under which position information was gathered, viewing perspective at the time the object or feature was measured, and the like. Further, some sources of location information may be more trustworthy than others. However, conventional maps used by vehicle ADS processing systems for autonomous and semi-autonomous driving functionality may provide little or no information regarding the reliability or accuracy of object and feature location data. Thus, while a vehicle ADS processing system may be configured to take into account confidence metrics for vehicles sensor data, conventional maps do not provide equivalent safety and confidence information regarding the map objects and features that the processor can take into account in localization, driving decisions, route planning, and the like.

Various embodiments overcome such limitations in digital map data used by vehicle ADS processing systems for autonomous and semi-autonomous driving functions by including safety and confidence information, such as a confidence metric, associated with objects and features in the digital map. Various embodiments include methods for using safety and confidence information, such as a confidence metrics, associated with objects and features in the digital map for performing autonomous and semi-autonomous driving functions. Some embodiments include methods for including safety and confidence information, such as a confidence metrics, associated with objects and features in digital maps suitable for use by vehicles equipped with vehicle ADS processing systems configured to perform operations of various embodiments.

In some embodiments, a vehicle processor may be configured to perform operations including accessing, from a map database accessible by the processor, map data regarding an object or feature in the vicinity of the vehicle and obtaining or accessing safety and/or confidence information associated with the object or feature map data regarding the in the vicinity of the vehicle. In some embodiments, the safety and/or confidence information may be included within the map database, such as part of map data records. In some embodiments, the safety and/or confidence information may be stored in a database separate from the map database, such as with an index or common data element that enables a vehicle processor to find the safety and/or confidence information corresponding to particular object and feature map data. The vehicle processor may then use the safety and/or confidence information in performing an autonomous or semi-autonomous driving action by the processor. In various embodiments, in performing an autonomous or semi-autonomous driving action the vehicle ADS processing system may adjust the autonomous driving level being performed by the system consistent with safety and confidence information (e.g., switching to a lower level of autonomous driving consistent with the safety information), take into account confidence information in object or feature map information as part of sensor fusion and navigation, route planning, object avoidance, discontinue or suspend an autonomous driving function, functionality, feature or action, and the like.

In some embodiments, the vehicle processor of the autonomous driving system may apply a weight to the accessed map data regarding the object or feature based upon the confidence information, and use weighted map data regarding the object or feature by the processor while performing a path planning, object avoidance, steering, and/or other autonomous driving action. In some embodiments, the vehicle processor of the autonomous driving system may perform operations including changing an autonomous driving mode of the vehicle implemented by the vehicle processor based on the safety and/or confidence information regarding the object or feature in the vicinity of the vehicle. In some embodiments or circumstances, the vehicle processor of the autonomous driving system may discontinue or suspend an autonomous driving function, functionality, feature or action.

In some embodiments, the vehicle processor of the autonomous driving system may obtain sensor data from vehicle sensors regarding objects and features in the vicinity of the vehicle, determine whether the sensor data indicate a new objects or features, or differences between sensor data and map data regarding an object or feature, and upload to a remote computing device information regarding the location of the new or changed object or feature including information regarding confidence (e.g., accuracy, precision, or reliability of the underlying sensor data) in the uploaded location information. In this manner, ADS-equipped vehicles may support the creation of map database including confidence information.

In some embodiments, a computing device, such as a server, may be configured to receive reports from ADS equipped vehicles that identify locations of objects and features that are new or differ from what is included in a map or maps used by vehicle ADS processing systems for autonomous and semi-autonomous driving functions, including safety and confidence information (e.g., a confidence metric) associated with each identified location. In such embodiments, the computing device may be configured to perform operations on the received information determining appropriate confidence information for added map data, and storing the confidence information in a database that is provided to or accessible by ADS-equipped vehicles.

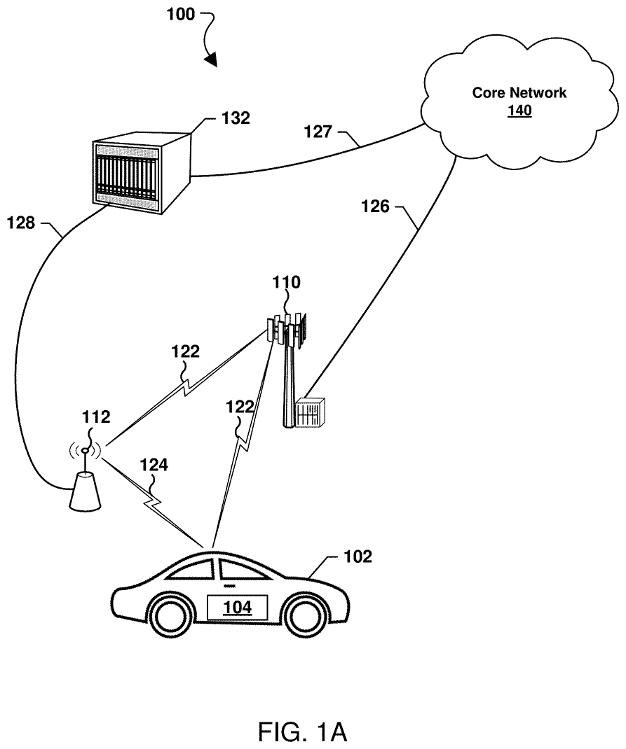

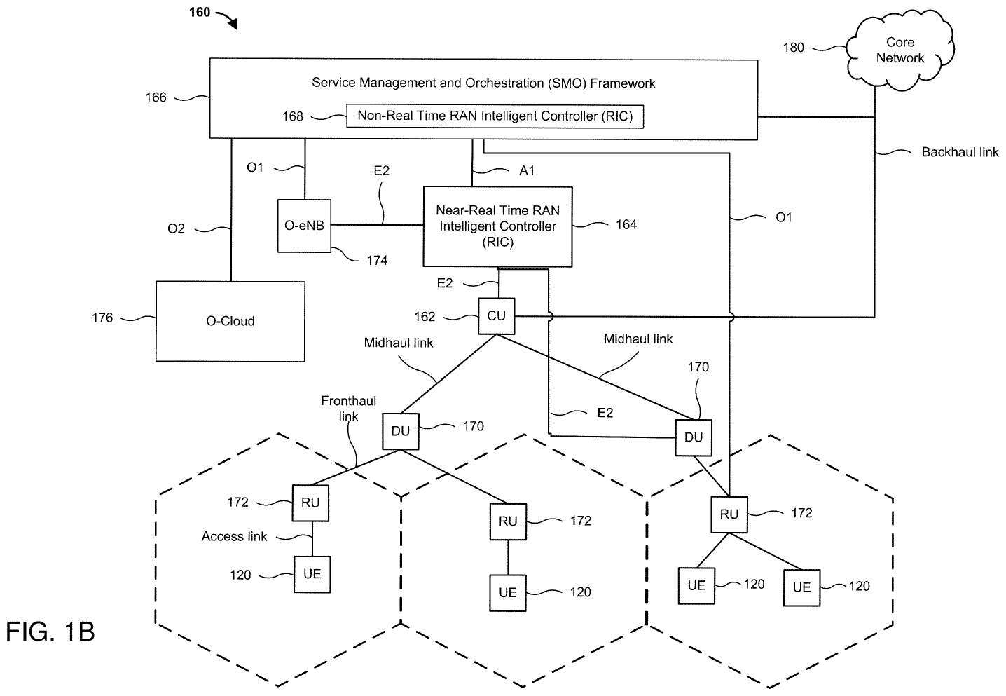

FIG. 1A is a system block diagram illustrating an example communication system 100 suitable for implementing the various embodiments. The communications system 100 include a 5G New Radio (NR) network, an ITS V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with an ADS 104 including wireless communication capabilities. The base station 110 may communicate with a core network 140 over a wired network 126. The communications system 100 also may include road side units 112 supporting V2X communications with vehicles 102 via V2X wireless communication links 124.

A base station 110 is a network elements that communicates with wireless devices (e.g., the vehicle 102) via, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Road side units may be coupled via wired networks 128 to a remote computing device 132 that may store and map data and confidence information for communication to vehicles 102 in accordance with various embodiments. Roadside units 112 may communicate via V2X wireless communication links 124 with ITS and ADS-equipped vehicles 102 for downloading information useful for ADS autonomous and semi-autonomous driving functions, including downloading map databases and other data bases including safety and/or confidence information databases in accordance with some embodiments. V2X wireless communication links 124 may also be used for uploading information regarding objects and features, and associated confidence measures, obtained by vehicle sensors to a remote computing device 132 for use in generating map data in accordance with some embodiments.

Cellular wireless communications, such as 5G wireless communications supported by base stations 110 may also be used for downloading information useful for ADS autonomous and semi-autonomous driving functions, including downloading map databases and other data bases including safety and/or confidence information databases, as well as for uploading information regarding objects and features, and associated confidence measures, obtained by vehicle sensors to a remote computing device 132 for use in generating map data in accordance with some embodiments. To support such communications, the remote computing device 132 hosting map and confidence information databases may be coupled to the core network via a communication link 127, such as the Internet, and map data and confidence information may be communicated to a base station 110 via a wired communication link 126 (e.g., Ethernet, fiber optic, etc.) for downloading to vehicles 102 via cellular wireless communication links 122 such as 5G wireless communication links.

Cellular wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network suitable for communicating map data to vehicles and communicating updated object/feature location data according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a vehicle ADS system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

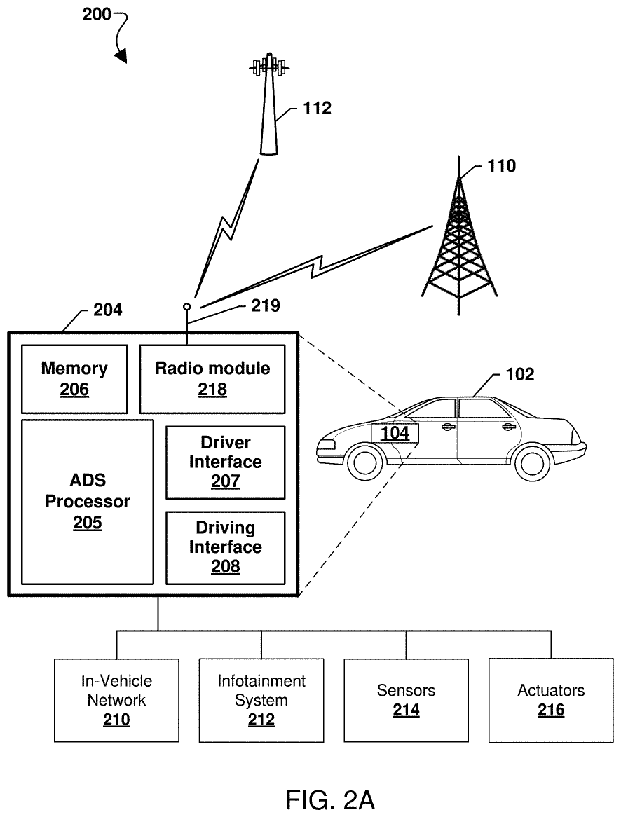

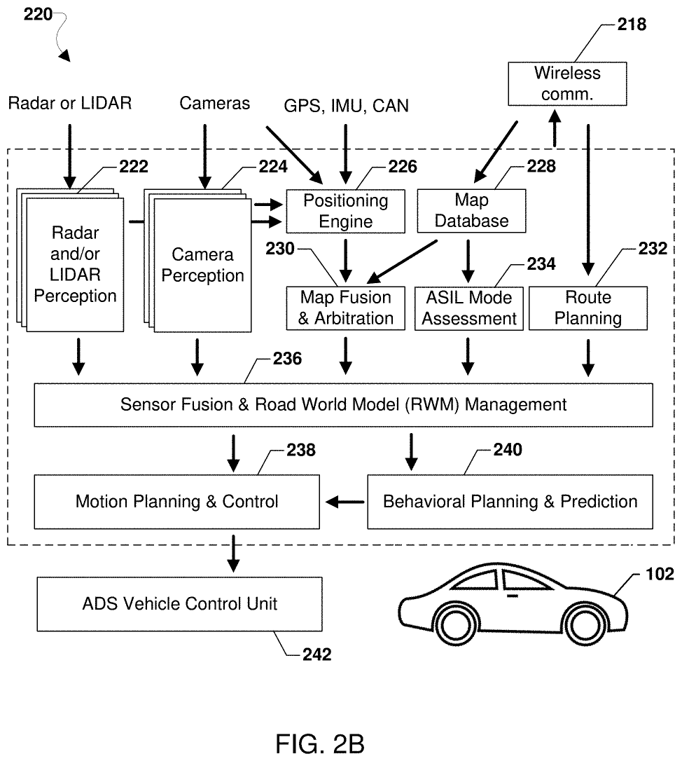

FIG. 2A is a component diagram of an example vehicle ADS system 200 suitable for implementing various embodiments. With reference to FIGS. 1A-2A, the system 200 may include a vehicle 102 that includes a vehicle ADS 104. The vehicle processing system 104 may communicate with various systems and devices, such as an in-vehicle network 210, an infotainment system 212, various sensors 214, various actuators 216, and a radio module 218 coupled to an antenna 219. The vehicle processing system 104 also may communicate with roadside units 112, cellular communication network base stations 110, and other external devices.

The vehicle ADS processing system 204 may include a processor 205, memory 206, an input module 207, an output module 208 and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The vehicle ADS processing system 204 may include a V2X antenna 219 coupled to the radio module 218 that is configured to communicate with one or more ITS participants (e.g., stations), a roadside unit 112, and a base station 110 or another suitable network access point. The V2X antenna 219 and radio module 218 may be configured to receive dynamic traffic flow feature information via vehicle-to-everything (V2X) communications. In various embodiments, the vehicle ADS processing system 204 may receive information from a plurality of information sources, such as the in-vehicle network 210, infotainment system 212, various sensors 214, various actuators 216, and the radio module 218. The vehicle ADS processing system 204 may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

FIG. 2B is a component block diagram illustrating components of an example vehicle ADS processing system stack 220. The vehicle management system 220 may include various subsystems, communication elements, computational elements, computing devices or units which may be utilized within a vehicle 102. With reference to FIGS. 1A-2A, the various computational elements, computing devices or units within the ADS processing system stack 220 may be implemented within a system of computing devices (i.e., subsystems) that communicate data and commands to each other via the in-vehicle network 210 (e.g., indicated by the arrows in FIG. 2B). In some implementations, the various computational elements, computing devices or units within the vehicle ADS processing system 104 may be implemented within a single computing device, such as separate threads, processes, algorithms or computational elements. Therefore, each subsystem/computational element illustrated in FIG. 2B is also generally referred to herein as a “layer” within a computational “stack” that constitutes the vehicle ADS processing system 220. However, the use of the terms layer and stack in describing various embodiments are not intended to imply or require that the corresponding functionality is implemented within a single vehicle computing device, although that is a potential implementation embodiment. Rather the use of the term “layer” is intended to encompass subsystems with independent processors, computational elements (e.g., threads, algorithms, subroutines, etc.) running in one or more computing devices, and combinations of subsystems and computational elements.

The vehicle ADS processing system stack 220 may include a radar and/or lidar perception layer 222, a camera perception layer 224, a positioning engine layer 226, a map database 228 including safety and/or confidence information (or a linked databased storing such information), a map fusion and arbitration layer 230, a route planning layer 232, an ASIL operating mode assessment layer 234, a sensor fusion and road world model (RWM) management layer 236, a motion planning and control layer 238, and a behavioral planning and prediction layer 240. The layers 222-240 are merely examples of some layers in one example configuration of the vehicle ADS processing system stack 220. In other configurations, other layers may be included, such as additional layers for other perception sensors (e.g., a lidar perception layer, etc.), additional layers for planning and/or control, additional layers for modeling, etc., and/or certain of the layers 222-240 may be excluded from the vehicle ADS processing system stack 220. Each of the layers 222-240 may exchange data, computational results and commands as illustrated by the arrows in FIG. 2B. Further, the vehicle ADS processing system stack 220 may receive and process data from sensors (e.g., radar, lidar, cameras, inertial measurement units (IMU) etc.), navigation information sources (e.g., GPS receivers, IMUs, etc.), vehicle networks (e.g., Controller Area Network (CAN) bus), and databases in memory (e.g., digital map data). The vehicle ADS processing system stack 220 may output vehicle control commands or signals to the ADS vehicle control unit 220, which is a system, subsystem or computing device that interfaces directly with vehicle steering, throttle and brake controls. The configuration of the vehicle ADS processing system stack 220 and ADS vehicle control unit 242 illustrated in FIG. 2A is merely an example configuration and other configurations of a vehicle management system and other vehicle components may be used. As an example, the configuration of the vehicle ADS processing system stack 220 and ADS vehicle control unit 242 illustrated in FIG. 2B may be used in a vehicle configured for autonomous or semi-autonomous operation while a different configuration may be used in a non-autonomous vehicle.

The radar and/or lidar perception layer 222 may receive data from one or more detection and ranging sensors, such as radar (e.g., 132) and/or lidar (e.g., 138), and process the data to recognize and determine locations of other vehicles and objects within a vicinity of the vehicle 100. The radar perception layer 22 may include use of neural network processing and artificial intelligence methods to recognize objects and vehicles, and pass such information on to the sensor fusion and RWM management layer 236.

The camera perception layer 224 may receive data from one or more cameras, such as cameras, and process the data to recognize and determine locations of other vehicles and objects within a vicinity of the vehicle 100. The camera perception layer 224 may include use of neural network processing and artificial intelligence methods to recognize objects and vehicles, and pass such information on to the sensor fusion and RWM management layer 236.

The positioning engine layer 226 may receive data from the radar and/or lidar perception layer 222, the camera perception layer 224, and various sources of navigation information, and process the data and information to determine a position of the vehicle 100. Various sources of navigation information may include, but is not limited to, a GPS receiver, an IMU, and/or other sources and sensors connected via a CAN bus. The positioning engine layer 226 may also utilize inputs from one or more cameras, such as cameras and/or any other available sensor capable of identifying and determining directions and distances to objects in the vicinity of the vehicle, such as radars, lidars, etc.

The vehicle ADS processing system 220 may include or be coupled to a vehicle wireless communication subsystem 218. The wireless communication subsystem 218 may be configured to communicate with highway communication systems, such as via V2X communication links (e.g., 124) and/or to remote information sources (e.g., computing device 132) via cellular wireless communication links (e.g., 122), such as via 5G cellular networks.

The map fusion and arbitration layer 230 may access the map database 228 for location information regarding nearby objects and features as well as safety and/or confidence information, and receive localizing/navigation information output from the positioning engine layer 226, and process the data to further determine the position of the vehicle 102 within the map, such as location within a lane of traffic, position within a street map, etc. sensor data may be stored in a memory (e.g., memory 312).

In determining the position of the vehicle 102 within the map, the positioning engine layer 226 take into consideration confidence information regarding locations of objects and features within the map as well as confidence (e.g., accuracy and/or precision information) in sensor data used in the positioning engine layer 226, such as confidence information related to radar, lidar and/or camera sensor data. The locations of objects and features within the map data may have varying levels of confidence, provided by safety and/or confidence information within the map database or a linked database, so the map fusion and arbitration layer 230 may take into account such information as well as confidence in sensor data in developing arbitrated map location information. For example, the map fusion and arbitration layer 230 may convert latitude and longitude information from GPS into locations within a surface map of roads contained in the map database and compare such locations to information received from radar, lidar and/or camera sensors that can identify and locate the objects and features associated with roads in the map data.

Similar to location information in some map objects and features and sensor accuracy and precision, GPS position fixes include some error, so the map fusion and arbitration layer 230 may function to determine a best guess location of the vehicle within a roadway based upon an arbitration between the GPS coordinates, sensor data, and map data regarding objects and features in and near the roadway. For example, while GPS coordinates may place the vehicle near the middle of a two-lane road in the sensor data, the map fusion and arbitration layer 230 may determine from the direction of travel that the vehicle is most likely aligned with the travel lane consistent with the direction of travel. The map fusion and arbitration layer 230 may pass arbitrated map location information to the sensor fusion and RWM management layer 236.

The route planning layer 232 may utilize sensor data, as well as inputs from an operator or dispatcher to plan a route to be followed by the vehicle 102 to a particular destination. The route planning layer 232 may pass map-based location information to the sensor fusion and RWM management layer 236. However, the use of a prior map by other layers, such as the sensor fusion and RWM management layer 236, etc., is not required. For example, other stacks may operate and/or control the vehicle based on perceptual data alone without a provided map, constructing lanes, boundaries, and the notion of a local map as perceptual data is received.

In embodiments including an ASIL mode assessment layer 234, that processing layer may use safety and/or confidence information regarding nearby objects and features identified in the map database 228 to select an appropriate ADS driving mode. In some embodiments, the ASIL mode assessment layer 234 may determine whether the current autonomous or semi-autonomous driving mode is consistent with or appropriate in view of safety and/or confidence information regarding nearby objects and features in the driving environment. For example, the ASIL mode assessment layer 234 may compare ASIL safety level information associated or linked to nearby objects and features in the map database, and initiate an action to change the driving mode to an ASIL level compatible or consistent with the ASIL safety level information of the nearby objects and features.

The sensor fusion and RWM management layer 236 may receive data and outputs produced by the radar and/or lidar perception layer 222, camera perception layer 224, map fusion and arbitration layer 230, route planning layer 232, and ASIL mode assessment layer 234, and use some or all of such inputs to estimate or refine the location and state of the vehicle 102 in relation to the road, other vehicles on the road, and other objects within a vicinity of the vehicle 100. For example, the sensor fusion and RWM management layer 236 may combine imagery data from the camera perception layer 224 with arbitrated map location information from the map fusion and arbitration layer 230 to refine the determined position of the vehicle within a lane of traffic. As another example, the sensor fusion and RWM management layer 236 may combine object recognition and imagery data from the camera perception layer 224 with object detection and ranging data from the radar and/or lidar perception layer 222 to determine and refine the relative position of other vehicles and objects in the vicinity of the vehicle. As another example, the sensor fusion and RWM management layer 236 may receive information from V2X communications (such as via the CAN bus) regarding other vehicle positions and directions of travel, and combine that information with information from the radar and/or lidar perception layer 222 and the camera perception layer 224 to refine the locations and motions of other vehicles. The sensor fusion and RWM management layer 236 may output refined location and state information of the vehicle 100, as well as refined location and state information of other vehicles and objects in the vicinity of the vehicle, to the motion planning and control layer 238 and/or the behavior planning and prediction layer 240.

As a further example, the sensor fusion and RWM management layer 236 may use dynamic traffic control instructions directing the vehicle 102 to change speed, lane, direction of travel, or other navigational element(s), and combine that information with other received information to determine refined location and state information. The sensor fusion and RWM management layer 236 may output the refined location and state information of the vehicle 102, as well as refined location and state information of other vehicles and objects in the vicinity of the vehicle 100, to the motion planning and control layer 238, the behavior planning and prediction layer 240 and/or devices remote from the vehicle 102, such as a data server, other vehicles, etc., via wireless communications, such as through C-V2X connections, other wireless connections, etc.

As a still further example, the sensor fusion and RWM management layer 236 may monitor perception data from various sensors, such as perception data from a radar and/or lidar perception layer 222, camera perception layer 224, other perception layer, etc., and/or data from one or more sensors themselves to analyze conditions in the vehicle sensor data. The sensor fusion and RWM management layer 236 may be configured to detect conditions in the sensor data, such as sensor measurements being at, above, or below a threshold, certain types of sensor measurements occurring, etc., and may output the sensor data as part of the refined location and state information of the vehicle 102 provided to the behavior planning and prediction layer 240 and/or devices remote from the vehicle 100, such as a data server, other vehicles, etc., via wireless communications, such as through C-V2X connections, other wireless connections, etc.

The behavioral planning and prediction layer 240 of the autonomous vehicle system stack 220 may use the refined location and state information of the vehicle 102 and location and state information of other vehicles and objects output from the sensor fusion and RWM management layer 236 to predict future behaviors of other vehicles and/or objects. For example, the behavioral planning and prediction layer 240 may use such information to predict future relative positions of other vehicles in the vicinity of the vehicle based on own vehicle position and velocity and other vehicle positions and velocity. Such predictions may take into account information from the map data and route planning to anticipate changes in relative vehicle positions as host and other vehicles follow the roadway. The behavioral planning and prediction layer 240 may output other vehicle and object behavior and location predictions to the motion planning and control layer 238. Additionally, the behavior planning and prediction layer 240 may use object behavior in combination with location predictions to plan and generate control signals for controlling the motion of the vehicle 102. For example, based on route planning information, refined location in the roadway information, and relative locations and motions of other vehicles, the behavior planning and prediction layer 240 may determine that the vehicle 102 needs to change lanes and accelerate, such as to maintain or achieve minimum spacing from other vehicles, and/or prepare for a turn or exit. As a result, the behavior planning and prediction layer 240 may calculate or otherwise determine a steering angle for the wheels and a change to the throttle setting to be commanded to the motion planning and control layer 238 and ADS vehicle control unit 242 along with such various parameters necessary to effectuate such a lane change and acceleration. One such parameter may be a computed steering wheel command angle.

The motion planning and control layer 238 may receive data and information outputs from the sensor fusion and RWM management layer 236, safety and/or confidence information from the map database 232 (or a separate and linked database), and other vehicle and object behavior as well as location predictions from the behavior planning and prediction layer 240, and use this information to plan and generate control signals for controlling the motion of the vehicle 102 and to verify that such control signals meet safety requirements for the vehicle 100. For example, based on route planning information, refined location in the roadway information, and relative locations and motions of other vehicles, the motion planning and control layer 238 may verify and pass various control commands or instructions to the ADS vehicle control unit 242.

The ADS vehicle control unit 242 may receive the commands or instructions from the motion planning and control layer 238 and translate such information into mechanical control signals for controlling wheel angle, brake and throttle of the vehicle 100. For example, ADS vehicle control unit 242 may respond to the computed steering wheel command angle by sending corresponding control signals to the steering wheel controller.

In various embodiments, the wireless communication subsystem 218 may communicate with other V2X system participants via wireless communication links to transmit sensor data, position data, vehicle data and data gathered about the environment around the vehicle by onboard sensors. Such information may be used by other V2X system participants to update stored sensor data for relay to other V2X system participants.

In various embodiments, the vehicle ADS processing system stack 220 may include functionality that performs safety checks or oversight of various commands, planning or other decisions of various layers that could impact vehicle and occupant safety. Such safety check or oversight functionality may be implemented within a dedicated layer or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 240 (or in a separate layer) may determine the current or future separate distance between another vehicle (as defined by the sensor fusion and RWM management layer 236) and the vehicle (e.g., based on the world model refined by the sensor fusion and RWM management layer 236), compare that separation distance to a safe separation distance parameter stored in memory, and issue instructions to the motion planning and control layer 238 to speed up, slow down or turn if the current or predicted separation distance violates the safe separation distance parameter. As another example, safety or oversight functionality in the motion planning and control layer 238 (or a separate layer) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

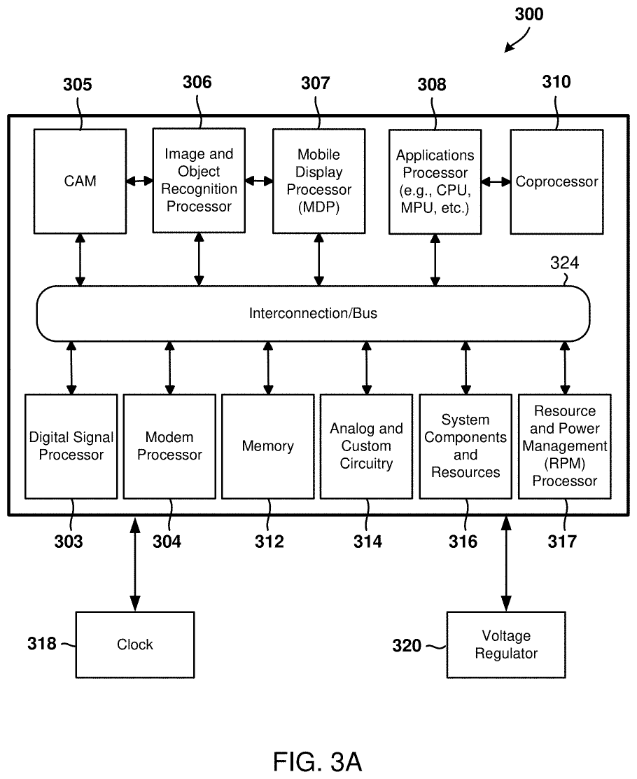

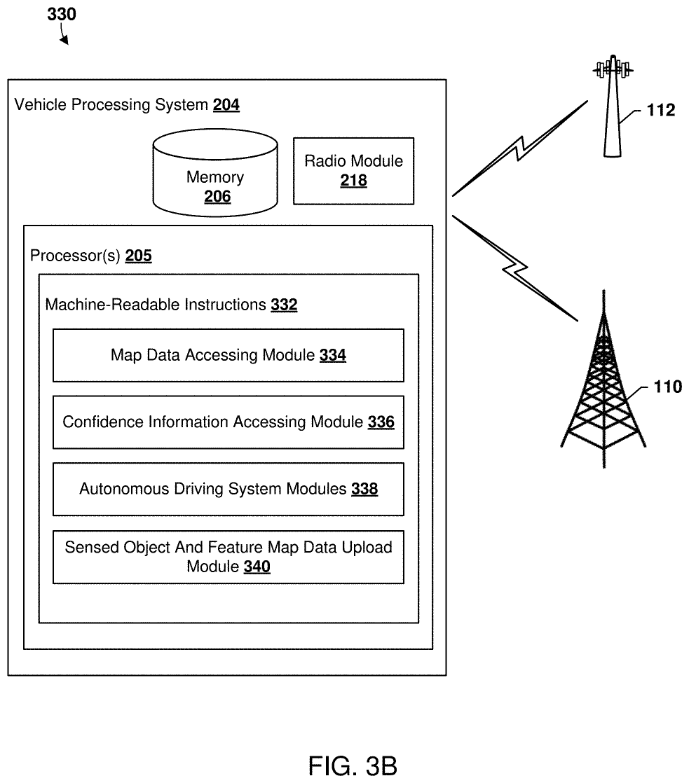

FIG. 3A illustrates an example system-on-chip (SOC) architecture of a processing device SOC 300 suitable for implementing various embodiments in vehicles. With reference to FIGS. 1A-3A, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles, and otherwise perform functions of the camera perception layer 224 as described. In some embodiments, the processor 306 may be configured to process radar or lidar data and perform functions of the radar and/or lidar perception layer 222 as described.

The system components and resources 316, analog and custom circuitry 314, and/or CAM 305 may include circuitry to interface with peripheral devices, such as cameras radar lidar electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

FIG. 3B is a component block diagram illustrating elements of a vehicle ADS 330 configured in accordance with various embodiments. With reference to FIGS. 1A-3B, the vehicle ADS 330 may include a vehicle ADS processing system 204 of a vehicle (e.g., 102), which may be configured to communicate with a roadside unit 112, and/or a cellular network base station 110.

The vehicle ADS processing system 204 may include one or more processors 205, memory 206, a radio module 218), and other components. The vehicle ADS processing system 204 may include a plurality of hardware, software, and/or firmware components operating together to provide the functionality attributed herein to the processor 205.

The memory 206 may include non-transitory storage media that electronically stores information. The electronic storage media of memory 206 may include one or both of system storage that is provided integrally (i.e., substantially non-removable) with the vehicle ADS processing system 204 and/or removable storage that is removably connectable to the vehicle ADS processing system 204 via, for example, a port (e.g., a universal serial bus (USB) port, a firewire port, etc.) or a drive (e.g., a disk drive, etc.). In various embodiments, memory 206 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The memory 206 may include one or more virtual storage resources (e.g., cloud storage, a virtual private network, and/or other virtual storage resources). Memory 206 may store software algorithms, information determined by processor(s) 205, information received from the one or more other vehicles 220, information received from the roadside unit 112, information received from the base station 110, and/or other information that enables the vehicle ADS processing system 204 to function as described herein.

The processor(s) 205 may include one of more local processors that may be configured to provide information processing capabilities in the vehicle ADS processing system 204. As such, the processor(s) 205 may include one or more of a digital processor, an analog processor, a digital circuit designed to process information, an analog circuit designed to process information, a state machine, and/or other mechanisms for electronically processing information. Although the processor(s) 205 is shown in FIG. 3B as a single entity, this is for illustrative purposes only. In some embodiments, the processor(s) 205 may include a plurality of processing units. These processing units may be physically located within the same device, or the processor(s) 205 may represent processing functionality of a plurality of devices distributed in the vehicle and operating in coordination.

The vehicle ADS processing system 204 may be configured by machine-readable instructions 332, which may include one or more instruction modules. The instruction modules may include computer program modules. In various embodiments, the instruction modules may include one or more of a map data accessing module 334, a confidence information accessing module 336, one or more autonomous driving modules 338, a sensed object and feature map data upload module 340, and/or other modules.

The map data accessing module 334 may be configured to access a map database, which may be stored in the memory 206 (or other vehicle memory), to obtain map data regarding objects and/or features in the vicinity of the vehicle.

The confidence information accessing module 334 may be configured to access a map database or other database indexed to map data, which may be stored in the memory 206 (or other vehicle memory), to obtain safety and/or confidence information associated with the map data related to objects and/or features in the vicinity of the vehicle. In some embodiments, the confidence information accessing module 334 may access a memory within the vehicle on which the confidence information is stored. In some embodiments, the confidence information accessing module 334 may access a network-accessible memory, such as a server storing the confidence information.

The autonomous driving system modules 338 may be configured to execute the various functions of autonomous and semi-autonomous driving by a vehicle ADS, including using the confidence information by the processor in performing an autonomous or semi-autonomous driving action by the processor as well as other operations of various embodiments. In some embodiments, the autonomous driving system modules 338 may use the confidence information by weighting corresponding map data and using weighted map data in driving operations. In some embodiments, the autonomous driving system modules 338 may take one or more actions to change a current autonomous driving mode to a driving move consistent with a safety level and/or confidence level of map data regarding nearby objects and features.

The sensed object and feature map data upload module 340 may be configured to identify objects and features detected by vehicle sensors that should be uploaded for consideration in generating map data, and uploading that information along with confidence information to a remote computing device. In some embodiments a processor executing the sensed object and feature map data upload module 340 may obtain sensor data from vehicle sensors regarding one or more objects and/or features in the vicinity of the vehicle, and determine whether the obtained sensor data regarding any object or feature in the vicinity of the vehicle differs from the map data regarding the object or feature obtained from the map database sufficiently to justify reporting the data to the remote computing device, such as by a threshold amount. When such an object and/or feature is identified in vehicle sensor data, the sensed object and feature map data upload module 340 may upload location information regarding the observed object and/or feature in conjunction with confidence information regarding that information.

The processor(s) 205 may be configured to execute the modules 332-340 and/or other modules by software, hardware, firmware, some combination of software, hardware, and/or firmware, and/or other mechanisms for configuring processing capabilities on processor(s) 205.

The description of the functionality provided by the different modules 332-340 is for illustrative purposes, and is not intended to be limiting, as any of modules 332-340 may provide more or less functionality than is described. For example, one or more of modules 332-340 may be eliminated, and some or all of its functionality may be provided by other ones of modules 332-340. As another example, processor(s) 205 may be configured to execute one or more additional modules that may perform some or all of the functionality attributed below to one of modules 332-340.

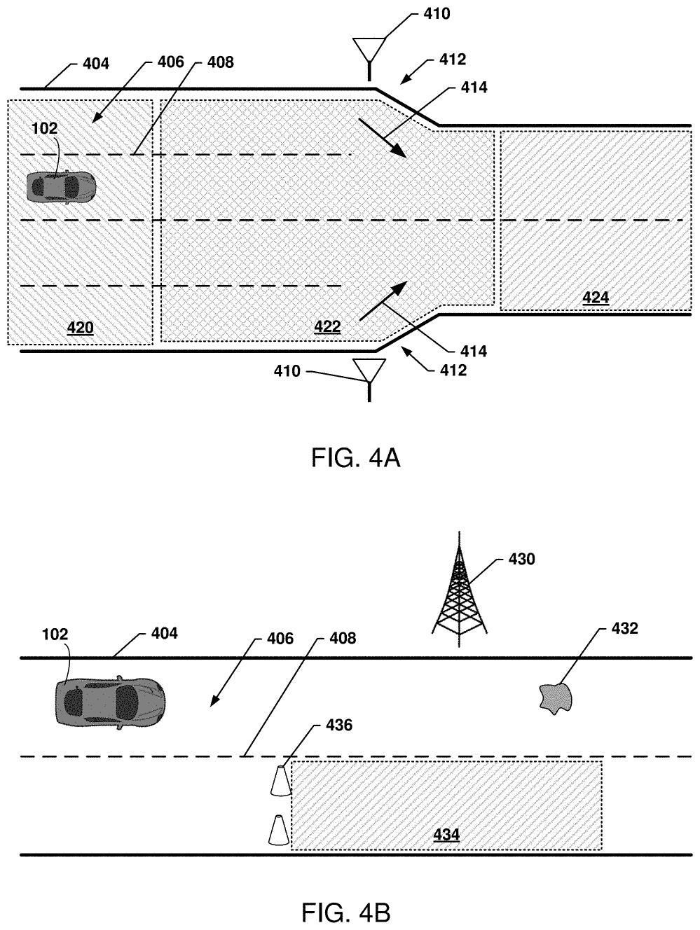

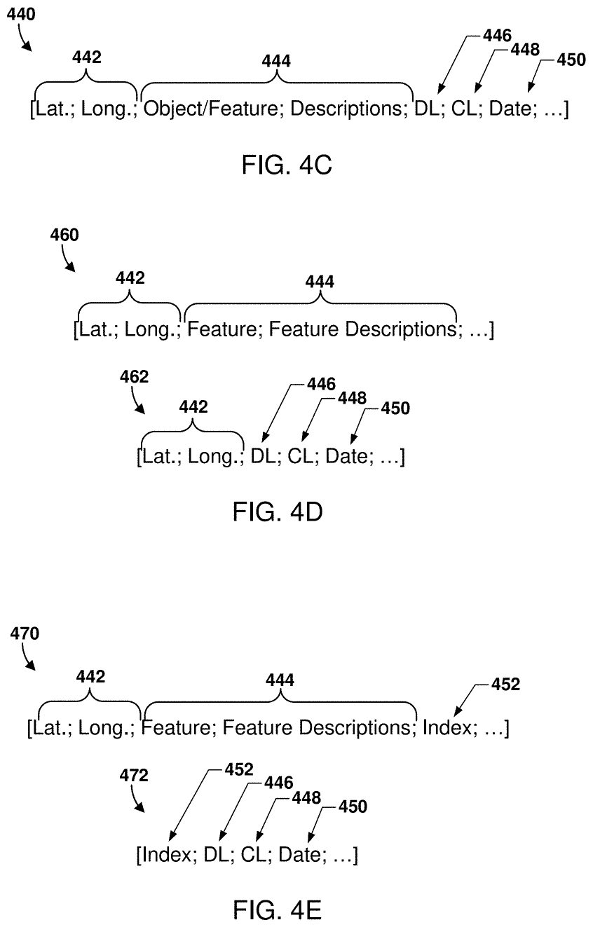

FIGS. 4A and 4B illustrate different forms of objects and features that may be present in a driving environment and represented in map data with safety and/or confidence information. For example, referring to FIG. 4A, objects and features within the vicinity of a vehicle 102 may include curbs 404 defining the edges of the roadway, traffic lanes 406 which may be divided by dividing lines 408. Such objects may also be associated with relevant descriptions, such as the height or nature of curbs 404, width and/or roadbed structure (e.g., asphalt, cement, dirt, etc.), and color (e.g., white, yellow, red, etc.) or nature (e.g., solid, dashed, doubled, etc.) of dividing lines 408. As another example, FIG. 4A illustrates a roadway feature in the form of a merger of lanes 412, which is signaled by yield signs 412 and arrows 414 in the roadway.

FIG. 4A also illustrates an example of features that may be included in map data in the form of zones or areas within the map in which certain driving conditions may be indicated, such as ASIL safety and/or autonomous driving levels. For example, the figure shows that the vehicle 102 is within driving area 420 that includes four driving lanes, such as typical in a large freeway setting. In such a driving area 420, autonomous driving may be feasible because traffic will be like, there are no turns or cross traffic and no access to the roadway by pedestrians. Thus, the driving area 420 provides an example of a roadway feature that may be assigned or associated with an ASIL safety or autonomous driving L4 or L5, indicating that an ADS equipped vehicle can operate fully autonomously without requiring the driver to pay attention. In various embodiments, the indication of L4 or L5 autonomous driving levels may be included in map data within a map database, or may be provided in a separate database that is linked or indexed to the map data so that the vehicle ADS processing system can be informed when the vehicle is in such locations.

Similarly, driving zone or area 422 that involves a merger of four lanes of traffic to two lanes of traffic, which can be challenging for autonomous driving systems (as well as human drivers) because the unpredictable nature of merging traffic that will occur within this area. Thus, the driving area 422 provides an example of a roadway feature that may be assigned or associated with an ASIL safety or autonomous driving L2 or L3, indicating that an ADS equipped vehicle should not operate fully autonomously, and should engage the driver to pay attention to the roadway and either standby to take control of the vehicle or begin steering the vehicle (if not take control). In some embodiments, the ADS of a vehicle 102 operating in full autonomous driving mode in area 420 may receive safety information from the map database or a linked database concerning area 422 as it approaches, and in response to receiving the L2 or L3 safety information alert the driver that a change in driving mode is commencing, and shift to the appropriate semi-autonomous driving mode upon entering area 422. Once past the merging area 422, the roadway may again be suitable for autonomous driving, in which case as the vehicle 102 approaches the area 424, the ADS may receive safety information for the area from the map database or a linked database, and notify the driver that the vehicle can be shifted to an autonomous driving mode. Such a shift from manual or semi-manual driving to a fully autonomous driving mode may require driver agreement.

The objects and features illustrated in FIG. 4A are examples of permanent objects and features that are unlikely to change over time. Thus, the age of the information in the map database concerning the objects and features 404-414 may not be relevant. For such objects and features, the safety and/or confidence information provided in map database or a linked database may not include information regarding the date or age of the associated map data.

However, some types of objects and features that may be included in map data may be temporary or change over a period time such that the date or age of the associated map data is relevant, and may be included in the safety and/or confidence information. FIG. 4B illustrates a few examples of objects and features that may change over time for which date or age information may be included in confidence information. For example, while the roadway curb 404, driving Lane 406, and dividing lines 408 are likely to remain as defined in the map data for a significant period of time, some roadways structures 430 that may be useful as navigation points for vehicle sensors (e.g., radar, lidar, cameras) may be modified or torn down over time. As another example, potholes 432 are roadway features that are relevant to autonomous driving but likely temporary. The location of potholes may be reported to a computing device that generates the map data by vehicles equipped with an ADS implementing various embodiments. The location of potholes may then be distributed to all autonomous vehicles via and updated map database. Because potholes may be repaired at some point, the date that the pothole was first reported or an age of the pothole location data may be included in the confidence information associated with the pothole map data that is included in the map database or a linked database. Providing this information may enable a vehicle ADS operating in autonomous driving mode to avoid confusion when approaching the location of a pothole 432 that is not observed by vehicle sensors (e.g., cameras) if the age of the pothole location data exceeds a threshold value.

FIG. 4B also illustrates an example of temporary objects and features that may be associated with roadway construction projects. For example, the map database may include locations of traffic cones 436 or barriers blocking off a line of travel, as well as areas of construction 434. Since highway construction is generally temporary, the age of the traffic cone and construction area location data may be included in the confidence information associated with the data that is included in the map database or a linked database. As an example of the value of such information, the vehicle ADS processing system may take into account the age of such construction area data when conducting route planning even before approaching the area, such as to elect to travel along a path including such construction if the age of the construction location data exceeds a threshold value.

FIGS. 4A and 4B also illustrate examples of objects and features that may be associated with different levels of confidence due to the manner in which the location information may be obtained. In the example illustrated in FIG. 4A, the roadway features of curbs 404, driving lanes 406, dividing lines 408, yield signs 410, areas 412 and street markings 414 may be defined through surveys that are very accurate, and thus have a high level of confidence in the location information. In the examples illustrated in FIG. 4B, structures on the side of the road, such as antennas 430, and temporary roadway features such as potholes 432, construction zones 434 and temporary barriers 436 may be detected and the location information obtained through vehicle sensors that are less accurate and subject to a variety of errors and limited precision. Thus, the confidence information included in the map database or a linked database for such objects and features 430, 432, 434, 436 may reflect a confidence level consistent with the accuracy, precision and overall confidence of the sensors and methods by which the locations were determined.

FIGS. 4C-4E illustrate three nonlimiting examples of data structures that may be used in various map-related databases for implementing various embodiments. In some embodiments, the map database including confidence information (e.g., as shown in FIG. 4C) or the confidence information database (e.g., as shown in FIGS. 4D and 4E) may be stored in a network location that ADS-equipped vehicles can access, such as to download the databases before beginning a trip or during a trip. In some embodiments the map database including confidence information (e.g., as shown in FIG. 4C) or the confidence information database (e.g., as shown in FIGS. 4D and 4E) may be transmitted or otherwise distributed to ADS-equipped vehicles, such as via over-the-air updates. For example, the map database including confidence information or the confidence information database may be accessed and/or received by ADS-equipped vehicles via a cellular network communication link 122 from base stations 110 and/or via V2X communication links 124 from roadside units 112.

In some embodiments, the safety and/or confidence information (including date or age information) may be included as data fields within the data record for individual objects and features included within the map database. FIG. 4C illustrates a nonlimiting example of such a data record 440, in which the data record may include location data 442 of a given object or feature, such as in the form of latitude and longitude coordinates as illustrated, or other forms of coordinates (e.g., map coordinate references). The map data record may also include a name or index of the object or feature as well as description (e.g., color) information 444. In a conventional map database, these information elements (i.e., 442, 444) may be all the information that is included in a given data record. In some embodiments, additional fields may be added to provide safety and confidence information, such as a data field for safety information, such as an ASIL driving level “DL” 446, a data field for confidence information “CL” 448, and the data field for the age or date 450 of the data record 440. Other data fields may also be included in the data record to provide further forms of safety and/or confidence information.

In some embodiments, the safety and/or confidence information (including date or age information) may be stored and made available in a separate database containing data records that are linked to specific data records of the map database. For example, FIG. 4D illustrates a data structure in which the safety and/or confidence information is provided in a separate database with the information stored in data records 462 linked to the location data 442 of a given map data record 460. In such examples, a vehicle ADS processing system may obtain the safety and/or confidence information from the separate confidence information database by using the location information 442 in a given map database data record 460 as lookup information to identify the corresponding data record 462 in the separate confidence information database. Such data records 462 may similarly include an ASIL driving level “DL” 446, a data field for confidence information “CL” 448, and the data field for the age or date 450, as well as other information.

FIG. 4E illustrates another nonlimiting example of a data structure in which the safety and/or confidence information is provided in a separate database with the information stored in data records 472 linked to an index 452 that is included in a given map data record 470. In this example embodiment, the data records 470 in the map database may include an index 452 that is used purpose of linking data records to the separate confidence information database. With data records 472 indexed in this manner, a vehicle ADS processing system accessing a given object or feature data record 470 in the map database may obtain the safety and/or confidence information by using the index 452 included in that data record to lookup the corresponding data record 472 in the separate confidence database. Such data records 472 may similarly include an ASIL driving level “DL” 446, a data field for confidence information “CL” 448, and the data field for the age or date 450, as well as other information.

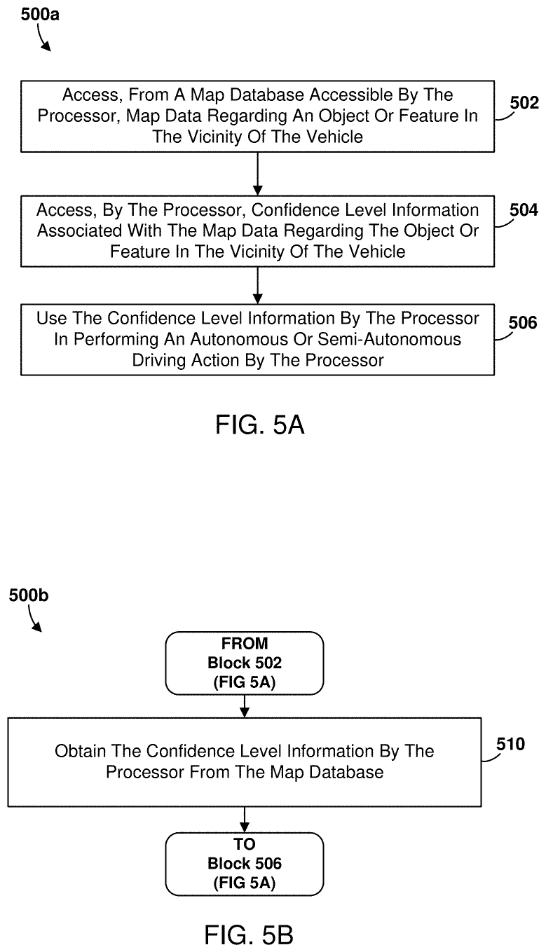

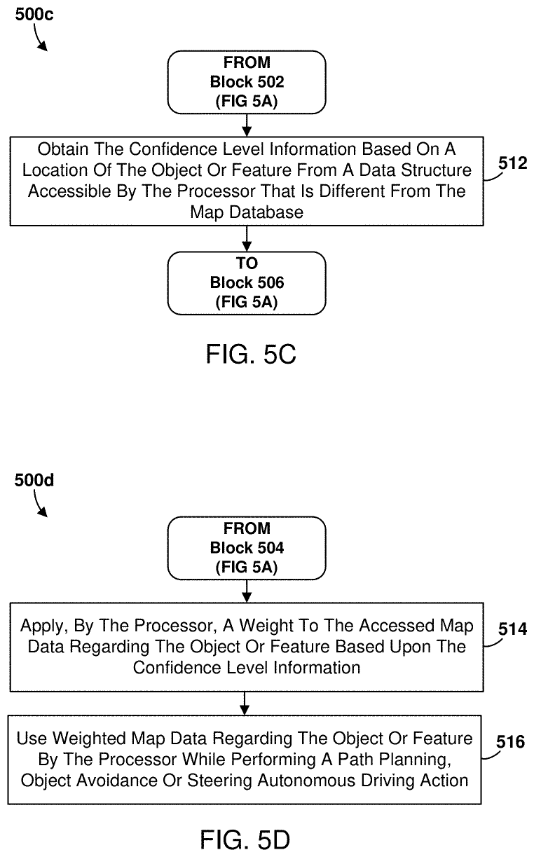

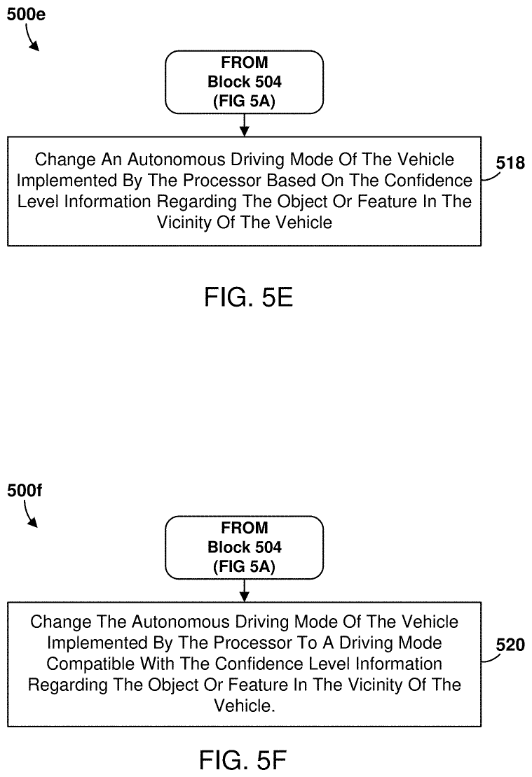

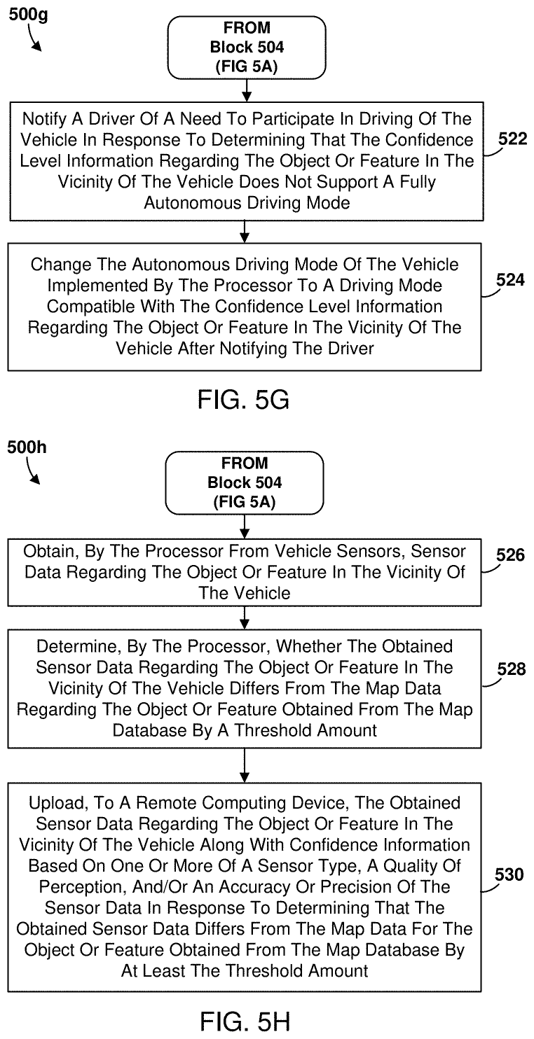

FIG. 5A is a process flow diagram of an example method 500a performed by a processor of an autonomous driving system of a vehicle for using safety and/or confidential information in or associated with map data in performing an autonomous driving function in accordance with various embodiments. FIGS. 5B-5H are process flow diagrams of example operations 500b-500h that may be performed as part as described for using safety and confidential information in or associated with map data in performing an autonomous driving function in accordance with some embodiments. With reference to FIGS. 1A-5H, the method 500a and the operations 500b-500h may be performed by a processor (e.g., 205, 300) of a vehicle ADS processing system or other vehicle processor (e.g., 104, 204, 205, 220, 300) that may be implemented in hardware elements, software elements, or a combination of hardware and software elements (referred to collectively as a “vehicle processor”).

In block 502, the vehicle processor may perform operations including accessing, from a map database accessible by the processor, map data regarding an object or feature in the vicinity of the vehicle. In some embodiments, the vehicle processor may access the map database for all data records of objects and features that are within a threshold distance of the current location of the vehicle. Described herein, the vehicle processor may be maintaining position information using a variety of sensors, including GPS coordinate data, dead reckoning, and visual navigation based upon the relative location of objects and features in the vicinity of the vehicle using information stored in already access map database records. For example, as the vehicle moves forward on a roadway, the vehicle processor may continually or periodically access to the map database to obtain data records of objects and features that are within a threshold distance ahead of the vehicle, thus accessing such data before the vehicle reaches the objects or features to give the vehicle ADS processing system time to conduct route planning and object avoidance processing. Means for performing the operations of block 502 may include memory (e.g., 206) storing a map database, and a processor (e.g., 205, 300) of a vehicle ADS processing system (e.g., 104, 204) executing the map data accessing module 334.

In block 504, the vehicle processor may perform operations including accessing, by the processor, confidence information associated with the map data regarding the object or feature in the vicinity of the vehicle. In some embodiments, the confidence information may an Automotive Safety Integrity Level (ASIL) autonomous driving level in the vicinity of the object or feature. Additionally or alternatively, in some embodiments the safety and/or confidence information may include an indication related to accuracy of the map data regarding the object or feature. Additionally or alternatively, in some embodiments the safety and/or confidence information may include an indication related to reliability of the map data regarding the object or feature. Additionally or alternatively, in some embodiments the safety and/or confidence information may include a statistical score indicative of a precision of the map data regarding the object or feature (e.g., statistical measure of precision, F₁ score, etc.). Additionally or alternatively, in some embodiments the safety and/or confidence information may include an age or freshness of the map data regarding the object or feature. For example, as described with reference to FIGS. 4C-4E, confidence information may be stored in the map database as part of object and feature data records or may be stored in a separate the linked data base, and the processor may obtain the confidence information using location or index values obtained from the map data record obtained in block 502. Means for performing the operations of block 504 may include memory (e.g., 206) storing a map database, and a processor (e.g., 205, 300) of a vehicle ADS processing system (e.g., 104, 204) executing the confidence information accessing module 336.

In block 506, the vehicle processor may perform operations including using the confidence information by the processor in performing an autonomous or semi-autonomous driving action. In some embodiments, the vehicle ADS processing system may adjust the autonomous driving level being performed by the system consistent with safety and confidence information (e.g., switching to a lower level of autonomous driving consistent with the safety information), take into account confidence information in object or feature map information as part of sensor fusion and navigation, route planning, object avoidance, and the like. In some embodiments, the vehicle processor of the autonomous driving system may discontinue an autonomous or semi-autonomous driving function, functionality, feature or action. Means for performing the operations of block 506 may include the in-vehicle network 210, and a processor (e.g., 205, 300) of a vehicle ADS processing system (e.g., 104, 204) executing the ADS processing system stack 220 and/or autonomous driving system modules 338.

FIGS. 5B-5H are process flow diagrams of example operations 500b-500h that may be performed as part as described for using safety and confidential information in or associated with map data in performing an autonomous driving function in accordance with some embodiments. The operations 500b-500h may be performed by a processor (e.g., 205) of a vehicle ADS processing system or other vehicle processor (e.g., 104, 204, 205, 220, 300) that may be implemented in hardware elements, software elements, or a combination of hardware and software elements (referred to collectively as a “vehicle processor”).

FIG. 5B illustrates operations 500b that may be performed by a vehicle ADS processing system for using safety and confidential information in or associated with map data in performing an autonomous driving function in accordance with some in accordance with some embodiments. The vehicle processor may perform operations including obtaining the confidence information by the processor from the map database in block 510. In some embodiments, the confidence information may be included in data elements associated with each object or feature in the map database. In some embodiments, the confidence information may be included as metadata linked to data elements associated with each object or feature in the map database. Thereafter, the vehicle processor may perform operations in block 506 of the method 500a as described. In various embodiments, information in the map database is obtained from one or more of system memory, a remote computing device, or another vehicle, and confidence information included in the map data may depend on a source of the map information. Means for performing the operations of block 510 may include memory (e.g., 206) storing a map database, and a processor (e.g., 205, 300) of a vehicle ADS processing system (e.g., 104, 204) executing the confidence information accessing module 336.

FIG. 5C illustrates operations 500c that may be performed by a vehicle processor for using safety and confidential information in or associated with map data in performing an autonomous driving function in accordance with some in accordance with some embodiments. With reference to FIGS. 1A-5C, following the operations in block 502 as described, the vehicle processor may perform operations including obtaining the confidence information based on a location of the object or feature from a data structure accessible by the processor that is different from the map database in block 512. For example, as described with reference to FIGS. 4D and 4E, the vehicle processor may use information obtained from the map database, such as the location of an object or feature or an index included in the map data record of an object or feature to look up the confidence information in the confidence database. Thereafter, the vehicle processor may perform operations in block 506 of the method 500a as described. Means for performing the operations of block 512 may include memory (e.g., 206) storing a map database, and a processor (e.g., 205, 300) of a vehicle ADS processing system (e.g., 104, 204) executing the confidence information accessing module 336.

After the operations in block 512, the vehicle processor may perform the operations in block 506 as described.

FIG. 5D illustrates operations 500d that may be performed by a vehicle processor for using safety and confidential information in or associated with map data in performing an autonomous driving function in accordance with some in accordance with some embodiments. With reference to FIGS. 1A-5D, following the operations in block 504, the vehicle processor of the autonomous driving system may perform operations including applying, by the vehicle processor, a weight to the accessed map data regarding the object or feature based upon the confidence information in block 514. For example, the vehicle processor may weight low confidence map data so that in map fusion operations (e.g., in a map fusion & arbitration layer 230) and/or road world model management (e.g., in a sensor fusion & RWM management layer 236), the map data can be applied or address in conjunction with sensor data according to the accuracy, precision and/or reliability of the data for motion planning and control. Means for performing the operations of block 504 may include memory (e.g., 206) storing a map database, and a processor (e.g., 205, 300) of a vehicle ADS processing system (e.g., 104, 204) executing the autonomous driving system module 338.

In block 516, the vehicle processor may perform operations including using weighted map data regarding the object or feature by the processor while performing a path planning, object avoidance or steering autonomous driving action. For example, the vehicle processor may assign a large weight (e.g., 1) to object and feature data for which the confidence information indicates significant confidence in the accuracy, precision and/or reliability of the data. As another example, the vehicle processor may assign a weight less that one to object and feature data for which the confidence information indicates that there is a degree of inaccuracy, imprecision and/or unreliability involved with the map data. As another example, the vehicle processor may assign a weight less that one to object and feature data that is old and thus may no longer be correct. Means for performing the operations of block 516 may include memory (e.g., 206) storing a map database, and a processor (e.g., 205, 300) of a vehicle ADS processing system (e.g., 104, 204) executing the autonomous driving system module 338.

FIG. 5E illustrates operations 500e that may be performed by a vehicle processor for using safety and confidential information in or associated with map data in performing an autonomous driving function in accordance with some in accordance with some embodiments. With reference to FIGS. 1A-5E, following the operations in block 504, the vehicle processor may perform operations including changing an autonomous driving mode of the vehicle implemented by the vehicle processor based on the confidence information regarding the object or feature in the vicinity of the vehicle in block 518. For example, the vehicle processor may evaluate map data regarding objects and features ahead of the vehicle based on the weights, such as in a manner similar to vehicle sensor data, when making steering decisions, collision avoidance maneuvers, path planning, and other autonomous driving functions. Means for performing the operations of block 518 may include the in-vehicle network 210, and a processor (e.g., 205, 300) of a vehicle ADS processing system (e.g., 104, 204) executing the ADS processing system stack 220 and/or autonomous driving system modules 338.

FIG. 5F illustrates operations 500f that may be performed by a vehicle processor for using safety and confidential information in or associated with map data in performing an autonomous driving function in accordance with some in accordance with some embodiments. With reference to FIGS. 1A-5F, following the operations in block 504, the vehicle processor may perform operations including changing the autonomous driving mode of the vehicle implemented by the vehicle processor to a driving mode compatible with the confidence information regarding the object or feature in the vicinity of the vehicle in block 520. For example, if the vehicle ADS processing system is operating in a full autonomous mode (e.g., L4 or L5) and the safety information associated with map data of objects, features or areas in the vicinity of the vehicle indicates that the driving environment (e.g., nature of the roadway, pedestrian conditions, ongoing construction, etc.) indicates the area is not safe for autonomous operations, the vehicle processor may take actions to transition to a driver-assisted or driver-in-charge operating mode. For example, the vehicle processor may emit a warning sound and/or display a notice to the driver that his/her attention is required and begin the process of switching operating modes in a safe manner. As another example, if the vehicle ADS processing system is operating in driver-in-control or driver-assisted mode (e.g., L2 or L3) and the safety information associated with map data of objects, features or areas in the vicinity of the vehicle indicate that the driving environment (e.g., nature of the roadway) indicates the area is now safe for autonomous operations, the vehicle processor may notify the driver that safe to change the vehicle operating mode accordingly. Means for performing the operations of block 520 may include the in-vehicle network 210, and a processor (e.g., 205, 300) of a vehicle ADS processing system (e.g., 104, 204) executing the ADS processing system stack 220 and/or autonomous driving system modules 338.

FIG. 5G illustrates operations 500g that may be performed by a vehicle processor for using safety and confidential information in or associated with map data in performing an autonomous driving function in accordance with some in accordance with some embodiments. With reference to FIGS. 1A-5G, following the operations in block 504, the vehicle processor may perform operations including notifying a driver of a need to participate in driving of the vehicle in response to determining that the confidence information regarding the object or feature in the vicinity of the vehicle does not support a fully autonomous driving mode in block 522. For example, the vehicle processor may emit a warning sound and/or display a notice to the driver that his/her attention is required and that the vehicle will shift operating modes accordingly upon receive an acknowledgement from the driver or the driver taking hold of the steering wheel. Means for performing the operations of block 522 may include the in-vehicle network 210, and a processor (e.g., 205, 300) of a vehicle ADS processing system (e.g., 104, 204) executing the ADS processing system stack 220 and/or autonomous driving system modules 338.

In block 524, the vehicle processor may perform operations including changing the autonomous driving mode of the vehicle implemented by the ADS after notifying the driver. For example, if the vehicle ADS processing system is operating in a full autonomous mode (e.g., L4 or L5) and the safety information associated with map data of objects, features or areas in the vicinity of the vehicle indicates that the driving environment is not safe for autonomous operations, the vehicle processor may shift to a driver-assisted or driver-in-charge operating mode based upon the safety information after receiving an acknowledgement or detecting that the driver has taken control. Means for performing the operations of block 524 may include the in-vehicle network 210, and a processor (e.g., 205, 300) of a vehicle ADS processing system (e.g., 104, 204) executing the ADS processing system stack 220 and/or autonomous driving system modules 338.

In some instances, the confidence information regarding the object or feature may be confidence information regarding objects and features within a defined area. In such instances, in block 526 the vehicle processor may perform operations including changing the autonomous driving mode of the vehicle implemented by the ADS to a driving mode compatible with the confidence information while the vehicle is in the defined area.

FIG. 5H illustrates operations 500h that may be performed by a vehicle processor for using safety and confidential information in or associated with map data in performing an autonomous driving function in accordance with some in accordance with some embodiments. With reference to FIGS. 1A-5H, following in the operations in block 504, the vehicle processor may perform operations including obtaining, by the vehicle processor from vehicle sensors, sensor data regarding the object or feature in the vicinity of the vehicle in block 526. For example, a sensor fusion & RWM management lawyer 236 executing in the vehicle processor may compare object or feature relative location and/or features to information determined by the map fusion & arbitration layer to recognize whether the information obtained from vehicle sensors (e.g., radar, lidar, cameras, etc.) is inconsistent with map data sufficient to indicate that the map data is wrong or missing detected objects of features. Means for performing the operations of block 526 may include vehicle sensors 214, the in-vehicle network 210, and a processor (e.g., 205, 300) of a vehicle ADS processing system (e.g., 104, 204) executing the ADS processing system stack 220 and/or autonomous driving system modules 338.

In block 528, the vehicle processor may perform operations including determining whether the obtained sensor data regarding the object or feature in the vicinity of the vehicle differs from the map data regarding the object or feature obtained from the map database by a threshold amount. For example, the sensor fusion & RWM management layer 236 executing in the vehicle processor may determine whether differences between information obtained from vehicle sensors and map data is of a magnitude indicating that the sensor data should be reported to a computing device that maintains the map data. Such a magnitude may be in the form of one or more thresholds of difference and/or may be in the form of a table that indicates the types and magnitudes of inconsistency that warrant sending the sensor data to the computing device that maintains the map data. Means for performing the operations of block 528 may include the in-vehicle network 210, and a processor (e.g., 205, 300) of a vehicle ADS processing system (e.g., 104, 204) executing the sensed object and feature map data upload module 340.

In block 530, the vehicle processor may perform operations including uploading to a remote computing device, the obtained sensor data regarding the object or feature in the vicinity of the vehicle along with confidence information based on one or more of a type of sensor used to detect or classify the object or feature, a quality of perception of the object or features achieved by the sensor, and/or an accuracy or precision of the sensor data in response to determining that the obtained sensor data differs from the map data regarding the object or feature obtained from the map database by at least the threshold amount. In some embodiments, the vehicle processor may upload the sensor data and confidence information to the computing device using a V2X network (e.g., 124) via a roadside unit (e.g., 112). In some embodiments and/or instances, the vehicle processor may upload the sensor data and confidence information to the computing device via a cellular wireless network (e.g., 122), such as a 5G network, via a base station (110). Means for performing the operations of block 530 may include a radio module 218 and a processor (e.g., 205, 300) of a vehicle ADS processing system (e.g., 104, 204) executing the sensed object and feature map data upload module 340.

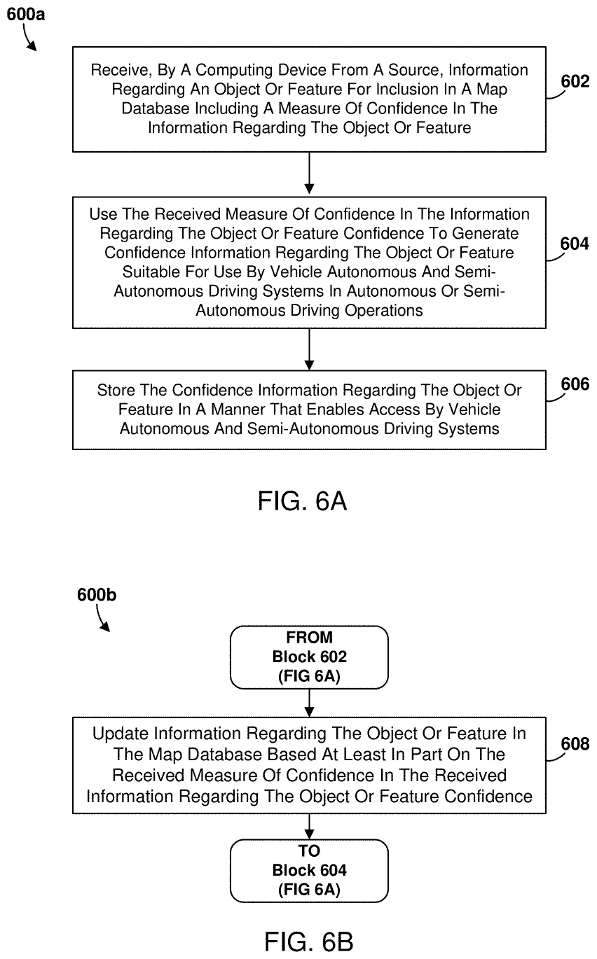

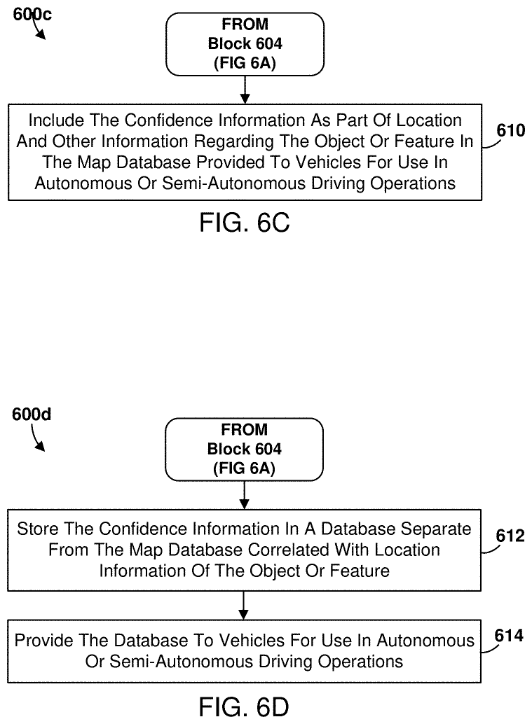

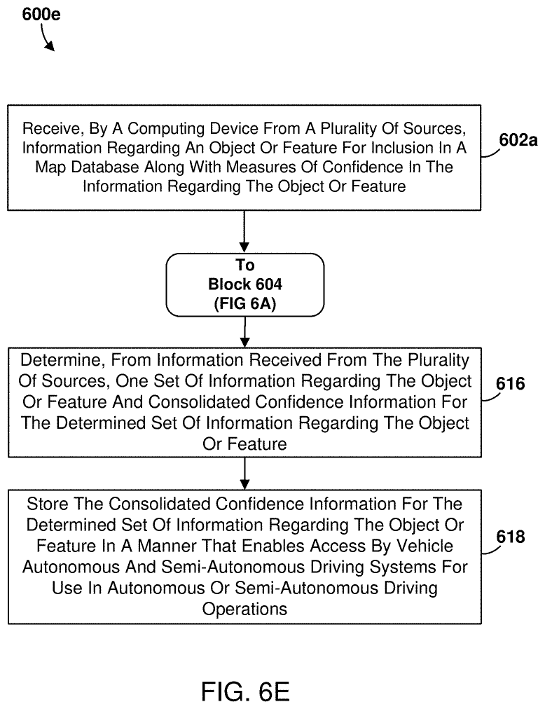

FIG. 6A is a process flow diagram of an example method 600a that may be performed by a computing device for including confidence information within map data useful by autonomous and semiautonomous driving systems in vehicles in accordance with various embodiments. With reference to FIGS. 1A-6A, the method 600a may be performed by computing device (e.g., a server)

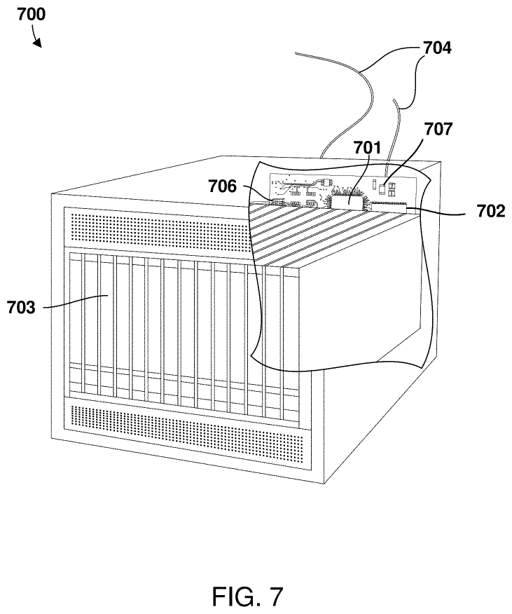

In block 602, computing device may perform operations including receiving, by the computing device from a source, information regarding an object or feature for inclusion in a map database including a measure of confidence in the information regarding the object or feature. The coordinate and description information related to each object or feature may be gathered from a variety of sources, including surveys of roadways and roadway features, overhead and satellite imagery, data from survey vehicles equipped to recognize and localize objects and features and report the data to the computing device, and from ADS-equipped vehicles reporting objects and features identified and localized by the vehicle's sensors (e.g., radar, lidar, cameras, etc.). Means for performing the operations of block 616 may include a computing device such as a server illustrated in FIG. 7, including a processor 701, volatile memory 702 and network access ports 704.

In block 604, the computing device may perform operations including using the received measure of confidence in the information regarding the object or feature confidence to generate confidence information regarding the object or feature suitable for use by vehicle autonomous and semi-autonomous driving systems in autonomous or semi-autonomous driving operations. In some embodiments, the confidence information may include one or more of an Automotive Safety Integrity Level (ASIL) autonomous driving level in the vicinity of the object or feature; an indication related to accuracy of the map data regarding the object or feature; an indication related to reliability of the map data regarding the object or feature; a statistical score indicative of a precision of the map data regarding the object or feature; or an age or freshness of the map data regarding the object or feature. ASIL information regarding map objects and features may be received from an authority or service that assigns safe autonomous driving levels based on the accuracy of map data and/or challenges posed by roadway features.

In some embodiments, the confidence information regarding the accuracy or precision of the map data may be established based upon the accuracy and reliability of the sources of or methods used to obtain the map data. The information used to generate the map database may come from a variety of sources, including survey vehicles, highway systems (e.g., cameras, traffic sensors, etc.) remote side units and from vehicles on the highway. In some embodiments, the confidence assigned to objects and features in the map data in block 616 may depend on the source of the map data. For example, the confidence level assigned to or associated with objects and features in a map generated from a single vehicle received via V2X communications may be less than the confidence level assigned to or associated with objects and features in a map generated by map crowd sourcing.

Means for performing the operations of block 616 may include a computing device such as a server illustrated in FIG. 7, including a processor 701 and volatile memory 702.

In block 606, the computing device may perform operations including storing the confidence information regarding the object or feature in a manner that enables access by vehicle autonomous and semi-autonomous driving systems in block 606. In some embodiments, the computing device may store the confidence information in the map data, such as in the same data records and the location and description information of the corresponding object and feature data. In some embodiments, the computing device may store the confidence information in a database (e.g., a confidence information database) separate from the map database, such as in data records with an index or information linking or indexing the confidence information record to the corresponding object and feature data record in the map database. In some embodiments as part of the operations in block 606, the computing device may store the map database including confidence information or store the confidence information database in a network location that ADS-equipped vehicles can access, such as to download the databases before beginning a trip or during a trip. In some embodiments as part of the operations in block 606, the computing device may transmit or otherwise distribute the map database including confidence information or the map database and a confidence information database to ADS-equipped vehicles, such as via over-the-air updates. Means for performing the operations of block 606 may include a computing device such as a server illustrated in FIG. 7, including a processor 701, volatile memory 702 and large capacity nonvolatile memory 703.

FIGS. 6B-6E are process flow diagrams of example operations 600b-600E that may be performed as part obtaining and storing safety and confidential information in or associated with map data in accordance with some embodiments. The operations 600b-600e may be performed by a computing device 700 (e.g., a remote server) that may be implemented in hardware elements, software elements, or a combination of hardware and software elements (referred to collectively as a “server”).

In some embodiments, receiving information regarding an object or feature for inclusion in a map database including a measure of confidence in the information regarding the object or feature may include receiving from one or more vehicles information including: a location of the object or feature; a characteristic of the object or feature; and a measure of confidence in the information regarding either the location or the characteristic of the object or feature.

Referring to FIG. 6B, following the operations in block 602, the computing device may perform operations further including updating information regarding the object or feature in the map database based at least in part on the received measure of confidence in the received information regarding the object or feature confidence in block 608. For example, the computing device may adjust the confidence information associated with the object or features based on the confidence information received from various ADS-equipped vehicles. Thereafter, the computing device may perform the operations in block 604 as described. Means for performing the operations of block 608 may include a computing device such as a server illustrated in FIG. 7, including a processor 701, volatile memory 702 and large capacity nonvolatile memory 703.

Referring to FIG. 6C, following the operations in block 604, the computing device may perform operations including storing the confidence information regarding the object or feature by including the confidence information as part of location and other information regarding the object or feature in the map database provided to vehicles for use in autonomous or semi-autonomous driving operations in block 610. For example, the computing device may store the confidence information as additional data fields within a data record of the corresponding map object or feature. Means for performing the operations of block 618 may include a computing device such as a server illustrated in FIG. 7, including a processor 701, volatile memory 702 and large capacity nonvolatile memory 703.

Referring to FIG. 6D, following the operations in block 604 as described, the computing device may perform operations including storing the confidence information in a database separate from the map database correlated with location information of the object or feature in block 612. For example, the computing device may store the confidence information in a data record of a data base or data table along with information or an index that is also in the map database corresponding data record of the map object or feature in the map database to enable ADS-equipped vehicles to find and access the confidence information. Means for performing the operations of block 618 may include a computing device such as a server illustrated in FIG. 7, including a processor 701, volatile memory 702 and large capacity nonvolatile memory 703.

In block 614 the computing device may perform operations including providing the database to vehicles for use in autonomous or semi-autonomous driving operations. In some embodiments, the computing device may periodically (or episodically upon completing an update) transmit the map database or just updates to the database to ADS-equipped vehicles. For example, the computing device may transmit updates to or updated map databases to ADS-equipped vehicles using a V2X network (e.g., 124) via a roadside units (e.g., 112). In some embodiments and/or instances, the computing device may transmit updates to or updated map databases to ADS-equipped vehicles using a cellular wireless network (e.g., 122), such as a 5G network, via a base station (110). Means for performing the operations of block 614 may include a computing device such as a server illustrated in FIG. 7, including a processor 701, volatile memory 702 and network access ports 704.

Referring to FIG. 6E, in some instances, new or changed objects or features in the roadway may be recognized and reported by numerous ADS-equipped vehicles. In such cases, the information such many reports may be used to determine a single set of map data with higher confidence than any one confidence information provided in vehicle reports. In the operations in block 602a, the computing device may perform operations including receiving, from a plurality of sources, information regarding the object or feature along with measures of confidence in the information regarding the object or feature. For example, when there is a change in a frequently traveled roadway, many ADS-equipped vehicle may report information regarding objects or features of the change. In some embodiments, the computing device may accumulate reports from a certain number of vehicles (i.e., wait until sufficient vehicles have reported the change) before generating consolidated information (e.g., by averaging) based on all reports. Means for performing the operations of block 602a may include a computing device such as a server illustrated in FIG. 7, including a processor 701, volatile memory 702 and network access ports 704. Thereafter, the computing device may perform the operations in block 604 as described.

Following the operations in block 604, the computing device may perform operations including determining, from information received from the plurality of sources, one set of information regarding the object or feature and consolidated confidence information for the determined set of information regarding the object or feature in block 616. For example, the vehicle processor may perform a statistical analysis on the information to select on set of object or feature data that best represents the information received from the plurality of sources, such as averaging or taking a weighted average using the confidence information associated with each reported sensor data as a weighting factor. In performing such statistical analysis, the computing device may determine a consolidated confidence level appropriate for the consolidate map data based on the number of sources of information used to generate the consolidated map data as well as the confidence information associated with each source of information. For example, if the one set of information regarding the object or feature stored in the map data is based on information received from a large number of sources (e.g., more than 10) and the various sources indicated high confidence in the reported information, the computing device may reflect a high level of confidence in the one set of object or feature data in the corresponding confidence information. Conversely, if the one set of information regarding the object or feature stored in the map data is based on information received from a small number of sources (e.g., three or fewer) and the various sources indicated low confidence in the reported information, the computing device may reflect a low level of confidence in the one set of object or feature data in the corresponding confidence information. Means for performing the operations of block 616 may include a computing device such as a server illustrated in FIG. 7, including a processor 701 and volatile memory 702.

In block 618, the computing device may perform operations including storing the consolidated confidence information for the determined set of information regarding the object or feature in a manner that enables access by vehicle autonomous and semi-autonomous driving systems for use in autonomous or semi-autonomous driving operations in block 618. For example, similar to the operations in block 612, the computing device may store the confidence information in a data record of a data base or data table along with information or an index that is also in the map database corresponding data record of the map object or feature in the map database to enable ADS-equipped vehicles to find and access the confidence information. Means for performing the operations of block 618 may include a computing device such as a server illustrated in FIG. 7, including a processor 701, volatile memory 702 and large capacity nonvolatile memory 703.

FIG. 7 is a component block diagram of a networked computing device suitable for use with various embodiments. With reference to FIGS. 1A-7, various embodiments (including, but not limited to, embodiments described with reference to FIGS. 6A-6E) may be implemented on a variety of computing devices, an example of which is illustrated in FIG. 7 in the form of a server computing device 700. A computing device 700 may include a processor 701 coupled to volatile memory 702 and a large capacity nonvolatile memory, such as a disk drive 703. The computing device 700 may also include a peripheral memory access device such as a floppy disc drive, compact disc (CD) or digital video disc (DVD) drive 706 coupled to the processor 701. The computing device 700 may also include network access ports 704 (or interfaces) coupled to the processor 701 for establishing data connections with a network, such as the Internet and/or a local area network coupled to other system computers and servers. The computing device 700 may include one or more transceivers 707 for sending and receiving electromagnetic radiation that may be connected to a wireless communication link. The computing device 700 may include additional access ports, such as USB, Firewire, Thunderbolt, and the like for coupling to peripherals, external memory, or other devices.

Implementation examples are described in the following paragraphs. While some of the following implementation examples are described in terms of example methods, further example implementations may include: the example methods discussed in the following paragraphs implemented by a vehicle processing device that may be an on-board unit as part of our coupled to an autonomous driving system configured with processor-executable instructions to perform operations of the methods 1-10 of the following implementation examples; the example methods discussed in the following paragraphs implemented by a computing device configured with processor-executable instructions to perform operations of the methods 11-16 of the following implementation examples; the example methods discussed in the following paragraphs implemented by a processing device including means for performing functions of the methods of the following implementation examples; and the example methods discussed in the following paragraphs implemented as a non-transitory processor-readable storage medium having stored thereon processor-executable instructions configured to cause a processor of a vehicle processing device or computing device to perform the operations of the methods of the following implementation examples.

Example 1. A method performed by a processor of an autonomous driving system of a vehicle for using map data in performing an autonomous driving function, including: accessing, from a map database accessible by the processor, map data regarding an object or feature in the vicinity of the vehicle; accessing, by the processor, confidence information associated with the map data regarding the object or feature in the vicinity of the vehicle; and using the confidence information by the processor in performing an autonomous or semi-autonomous driving action.

Example 2. The method of example 1, in which the confidence information includes an ASIL autonomous driving level in the vicinity of the object or feature.

Example 3. The method of either of example 1 or 2, in which the confidence information includes an indication related to accuracy of the map data regarding the object or feature.

Example 4. The method of any of examples 1-3, in which the confidence information includes an indication related to reliability of the map data regarding the object or feature.

Example 5. The method of any of examples 1-4, in which the confidence information includes a statistical score indicative of a precision of the map data regarding the object or feature.

Example 6. The method of any of examples 1-5, in which the confidence information includes an age or freshness of the map data regarding the object or feature.

Example 7. The method of any of examples 1-6, in which accessing confidence information associated with the map data regarding the object or feature in the vicinity of the vehicle includes obtaining the confidence information by the processor from the map database, in which information in the map database is obtained from one or more of system memory, a remote computing device, or another vehicle.

Example 8. The method of any of examples 1-7, in which accessing confidence information associated with the map data regarding the object or feature in the vicinity of the vehicle includes obtaining the confidence information based on a location of the object or feature from a data structure accessible by the processor that is different from the map database.

Example 9. The method of any of examples 1-8, in which using the confidence information in performing an autonomous or semi-autonomous driving action by the vehicle includes applying, by the processor, a weight to the accessed map data regarding the object or feature based upon the confidence information, and using weighted map data regarding the object or feature by the processor while performing a path planning, object avoidance or steering autonomous driving action.

Example 10. The method of any of examples 1-9, in which using the confidence information in performing an autonomous or semi-autonomous driving action by the vehicle includes changing an autonomous driving mode of the vehicle implemented by the processor based on the confidence information regarding the object or feature in the vicinity of the vehicle.

Example 11. The method of any of examples 1-10, in which changing the autonomous driving mode of the vehicle implemented by the processor based on the confidence information regarding the object or feature in the vicinity of the vehicle includes changing the autonomous driving mode of the vehicle implemented by the processor to a driving mode compatible with the confidence information regarding the object or feature in the vicinity of the vehicle.

Example 12. The method of any of examples 1-11, further including notifying a driver of a need to participate in driving of the vehicle in response to determining that the confidence information regarding the object or feature in the vicinity of the vehicle does not support a fully autonomous driving mode, and changing the autonomous driving mode of the vehicle implemented by the processor after notifying the driver.

Example 13. The method of any of examples 1-12, in which: the confidence information regarding the object or feature includes confidence information regarding objects and features within a defined area; and changing the autonomous driving mode of the vehicle implemented by the processor based on the confidence information regarding the object or feature in the vicinity of the vehicle includes changing the autonomous driving mode of the vehicle implemented by the processor to an autonomous driving mode consistent with the confidence information while the vehicle is in the defined area.

Example 14. The method of any of examples 1-13, further including; obtaining, by the processor from vehicle sensors, sensor data regarding the object or feature in the vicinity of the vehicle; determining, by the processor, whether the obtained sensor data regarding the object or feature in the vicinity of the vehicle differs from the map data regarding the object or feature obtained from the map database by a threshold amount; and uploading, by the processor to a remote computing device, the obtained sensor data regarding the object or feature in the vicinity of the vehicle along with confidence information based on one or more of a type of sensor used to detect or classify the object or feature, a quality of perception of the object or features achieved by the sensor, or an accuracy or precision of the sensor data in response to determining that the obtained sensor data differs from the map data regarding the object or feature obtained from the map database by at least the threshold amount.

Example 15. A method performed by a computing device for including safety and confidence information within map data useful by autonomous and semiautonomous driving systems in vehicles, including; receiving, by the computing device from a source, information regarding an object or feature for inclusion in a map database including a measure of confidence in the information regarding the object or feature; using the received measure of confidence in the information regarding the object or feature to generate safety and confidence information regarding the object or feature suitable for use by vehicle autonomous and semi-autonomous driving systems in autonomous or semi-autonomous driving operations, in which the safety and confidence information includes one or more of an ASIL autonomous driving level in the vicinity of the object or feature; an indication related to accuracy of the map data regarding the object or feature; a statistical score indicative of a precision of the map data regarding the object or feature; an indication related to reliability of the map data regarding the object or feature; or an age or freshness of the map data regarding the object or feature; and storing the safety and confidence information regarding the object or feature in a manner that enables access by vehicle autonomous and semi-autonomous driving systems.

Example 16. The method of example 15, in which receiving information regarding an object or feature for inclusion in a map database including a measure of confidence in the information regarding the object or feature includes receiving from one or more vehicles information including: a location of the object or feature; a characteristic of the object or feature; and a measure of confidence in the information regarding either the location or the characteristic of the object or feature.

Example 17. The method of either of examples 15 or 16, further including updating information regarding the object or feature in the map database based at least in part on the received measure of confidence in the received information regarding the object or feature confidence.

Example 18. The method of any of examples 15-17, in which storing the safety and confidence information regarding the object or feature includes including the safety and confidence information as part of location and other information regarding the object or feature in the map database provided to vehicles for use in autonomous or semi-autonomous driving operations.

Example 19. The method of any of examples 15-18, in which storing the safety and confidence information regarding the object or feature includes: storing the safety and confidence information in a database separate from the map database correlated with location information of the object or feature; and providing the database to vehicles for use in autonomous or semi-autonomous driving operations.

Example 20. The method of any of examples 15-19, in which: receiving information regarding an object or feature for inclusion in a map database includes receiving, from a plurality of sources, information regarding the object or feature along with measures of confidence in the information regarding the object or feature, the method further including determining, from information received from the plurality of sources, one set of information regarding the object or feature and consolidated safety and confidence information for the determined set of information regarding the object or feature; and storing safety and confidence information regarding the object or feature in a manner that enables access by vehicle autonomous and semi-autonomous driving systems for use in autonomous or semi-autonomous driving operations includes storing the consolidated safety and confidence information for the determined set of information regarding the object or feature in a manner that enables access by vehicle autonomous and semi-autonomous driving systems for use in autonomous or semi-autonomous driving operations.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of an autonomous driving system of a vehicle for using map data in performing an autonomous driving function, comprising:
accessing, from a map database accessible by the processor, map data regarding an object or feature in the vicinity of the vehicle;
accessing, by the processor, confidence information associated with the map data regarding the object or feature in the vicinity of the vehicle; and
using the confidence information by the processor in performing an autonomous or semi-autonomous driving action.

2. The method of claim 1, wherein the confidence information comprises an Automotive Safety Integrity Level (ASIL) autonomous driving level in the vicinity of the object or feature.

3. The method of claim 1, wherein the confidence information comprises an indication related to accuracy of the map data regarding the object or feature.

4. The method of claim 1, wherein the confidence information comprises an indication related to reliability of the map data regarding the object or feature.

5. The method of claim 1, wherein the confidence information comprises a statistical score indicative of a precision of the map data regarding the object or feature.

6. The method of claim 1, wherein the confidence information comprises an age or freshness of the map data regarding the object or feature.

7. The method of claim 1, wherein accessing confidence information associated with the map data regarding the object or feature in the vicinity of the vehicle comprises:
obtaining the confidence information by the processor from the map database, wherein information in the map database is obtained from one or more of system memory, a remote computing device, or another vehicle.

8. The method of claim 1, wherein accessing confidence information associated with the map data regarding the object or feature in the vicinity of the vehicle comprises:
obtaining the confidence information based on a location of the object or feature from a data structure accessible by the processor that is different from the map database.

9. The method of claim 1, wherein using the confidence information in performing an autonomous or semi-autonomous driving action by the vehicle comprises:
applying, by the processor, a weight to the accessed map data regarding the object or feature based upon the confidence information; and
using weighted map data regarding the object or feature by the processor while performing a path planning, object avoidance or steering autonomous driving action.

10. The method of claim 1, wherein using the confidence information in performing an autonomous or semi-autonomous driving action by the vehicle comprises:
changing an autonomous driving mode of the vehicle implemented by the processor based on the confidence information regarding the object or feature in the vicinity of the vehicle.

11. The method of claim 10, wherein changing the autonomous driving mode of the vehicle implemented by the processor based on the confidence information regarding the object or feature in the vicinity of the vehicle comprises:
changing the autonomous driving mode of the vehicle implemented by the processor to a driving mode compatible with the confidence information regarding the object or feature in the vicinity of the vehicle.

12. The method of claim 10, further comprising:
notifying a driver of a need to participate in driving of the vehicle in response to determining that the confidence information regarding the object or feature in the vicinity of the vehicle does not support a fully autonomous driving mode; and
changing the autonomous driving mode of the vehicle implemented by the processor after notifying the driver.

13. The method of claim 10, wherein:
the confidence information regarding the object or feature comprises confidence information regarding objects and features within a defined area; and
changing the autonomous driving mode of the vehicle implemented by the processor based on the confidence information regarding the object or feature in the vicinity of the vehicle comprises changing the autonomous driving mode of the vehicle implemented by the processor to an autonomous driving mode consistent with the confidence information while the vehicle is in the defined area.

14. The method of claim 1, further comprising:
obtaining, by the processor from vehicle sensors, sensor data regarding the object or feature in the vicinity of the vehicle;
determining, by the processor, whether the obtained sensor data regarding the object or feature in the vicinity of the vehicle differs from the map data regarding the object or feature obtained from the map database by a threshold amount; and
uploading, by the processor to a remote computing device, the obtained sensor data regarding the object or feature in the vicinity of the vehicle along with confidence information based on one or more of a type of sensor used to detect or classify the object or feature, a quality of perception of the object or features achieved by the sensor, or an accuracy or precision of the sensor data in response to determining that the obtained sensor data differs from the map data regarding the object or feature obtained from the map database by at least the threshold amount.

15. An autonomous driving system for use in a vehicle, comprising:
a memory; and
a processor coupled to the memory and configured to:
access map data regarding an object or feature in the vicinity of the vehicle;
access confidence information associated with the map data regarding the object or feature in the vicinity of the vehicle; and
use the confidence information in performing an autonomous or semi-autonomous driving action.

16. The autonomous driving system of claim 15, wherein the confidence information comprises an Automotive Safety Integrity Level (ASIL) autonomous driving level in the vicinity of the object or feature.

17. The autonomous driving system of claim 15, wherein the confidence information comprises an indication related to accuracy of the map data regarding the object or feature.

18. The autonomous driving system of claim 15, wherein the confidence information comprises an indication related to reliability of the map data regarding the object or feature.

19. The autonomous driving system of claim 15, wherein the confidence information comprises a statistical score indicative of a precision of the map data regarding the object or feature.

20. The autonomous driving system of claim 15, wherein the confidence information comprises an age or freshness of the map data regarding the object or feature.

21. The autonomous driving system of claim 15, wherein the processor is further configured to access confidence information associated with the map data regarding the object or feature in the vicinity of the vehicle by:
obtaining the confidence information from the map database, wherein information in the map database is obtained from one or more of system memory, a remote computing device, or another vehicle.

22. The autonomous driving system of claim 15, wherein the processor is further configured to access confidence information associated with the map data regarding the object or feature in the vicinity of the vehicle by:
obtaining the confidence information based on a location of the object or feature from a data structure accessible that is different from the map database.

23. The autonomous driving system of claim 15, wherein the processor is further configured to use the confidence information in performing an autonomous or semi-autonomous driving action by the vehicle by:
applying a weight to the accessed map data regarding the object or feature based upon the confidence information; and
using weighted map data regarding the object or feature while performing a path planning, object avoidance or steering autonomous driving action.

24. The autonomous driving system of claim 15, wherein the processor is further configured to use the confidence information in performing an autonomous or semi-autonomous driving action by the vehicle by:
changing an autonomous driving mode of the vehicle implemented by the processor based on the confidence information regarding the object or feature in the vicinity of the vehicle.

25. The autonomous driving system of claim 24, wherein the processor is further configured to change the autonomous driving mode of the vehicle implemented by the processor based on the confidence information regarding the object or feature in the vicinity of the vehicle by:
changing the autonomous driving mode of the vehicle to a driving mode compatible with the confidence information regarding the object or feature in the vicinity of the vehicle.

26. The autonomous driving system of claim 24, wherein the processor is further configured to:
notify a driver of a need to participate in driving of the vehicle in response to determining that the confidence information regarding the object or feature in the vicinity of the vehicle does not support a fully autonomous driving mode; and
change the autonomous driving mode of the vehicle after notifying the driver.

27. The autonomous driving system of claim 24, wherein:
the confidence information regarding the object or feature comprises confidence information regarding objects and features within a defined area; and
the processor is further configured to change the autonomous driving mode of the vehicle based on the confidence information regarding the object or feature in the vicinity of the vehicle by changing the autonomous driving mode to an autonomous driving mode consistent with the confidence information while the vehicle is in the defined area.

28. The autonomous driving system of claim 15, wherein the processor is further configured to:
obtain sensor data from vehicle sensors regarding the object or feature in the vicinity of the vehicle;
determine whether the obtained sensor data regarding the object or feature in the vicinity of the vehicle differs from the map data regarding the object or feature obtained from the map database by a threshold amount; and
upload, to a remote computing device, the obtained sensor data regarding the object or feature in the vicinity of the vehicle along with confidence information regarding a type of sensor used to detect or classify the object or feature, a quality of perception of the object or features achieved by the sensor, and an accuracy or precision of the sensor data in response to determining that the obtained sensor data differs from the map data regarding the object or feature obtained from the map database by at least the threshold amount.

29. A method performed by a computing device for including safety and confidence information within map data useful by autonomous and semiautonomous driving systems in vehicles, comprising:
receiving, by the computing device from a source, information regarding an object or feature for inclusion in a map database including a measure of confidence in the information regarding the object or feature;
using the received measure of confidence in the information regarding the object or feature to generate safety and confidence information regarding the object or feature suitable for use by vehicle autonomous and semi-autonomous driving systems in autonomous or semi-autonomous driving operations, wherein the safety and confidence information comprises one or more of an Automotive Safety Integrity Level (ASIL) autonomous driving level in the vicinity of the object or feature; an indication related to accuracy of the map data regarding the object or feature; a statistical score indicative of a precision of the map data regarding the object or feature; an indication related to reliability of the map data regarding the object or feature; or an age or freshness of the map data regarding the object or feature; and
storing the safety and confidence information regarding the object or feature in a manner that enables access by vehicle autonomous and semi-autonomous driving systems.

30. The method of claim 29, wherein receiving information regarding an object or feature for inclusion in a map database including a measure of confidence in the information regarding the object or feature comprises receiving from one or more vehicles information including: a location of the object or feature; a characteristic of the object or feature; and a measure of confidence in the information regarding either the location or the characteristic of the object or feature.

31. The method of claim 29, further comprising updating information regarding the object or feature in the map database based at least in part on the received measure of confidence in the received information regarding the object or feature confidence.

32. The method of claim 29, wherein storing the safety and confidence information regarding the object or feature comprises including the safety and confidence information as part of location and other information regarding the object or feature in the map database provided to vehicles for use in autonomous or semi-autonomous driving operations.

33. The method of claim 29, wherein storing the safety and confidence information regarding the object or feature comprises:
storing the safety and confidence information in a database separate from the map database correlated with location information of the object or feature; and
providing the database to vehicles for use in autonomous or semi-autonomous driving operations.

34. The method of claim 29, wherein:
receiving information regarding an object or feature for inclusion in a map database comprises receiving, from a plurality of sources, information regarding the object or feature along with measures of confidence in the information regarding the object or feature;
the method further comprises determining, from information received from the plurality of sources, one set of information regarding the object or feature and consolidated safety and confidence information for the determined set of information regarding the object or feature; and
storing safety and confidence information regarding the object or feature in a manner that enables access by vehicle autonomous and semi-autonomous driving systems for use in autonomous or semi-autonomous driving operations comprises storing the consolidated safety and confidence information for the determined set of information regarding the object or feature in a manner that enables access by vehicle autonomous and semi-autonomous driving systems for use in autonomous or semi-autonomous driving operations.

35. A computing device, comprising:
a network connection configured to receive messages from and send messages to vehicles configured with vehicle autonomous and semi-autonomous driving systems; and
a processor coupled to the network connection and configured to:
receive information received from a source regarding an object or feature for inclusion in a map database including a measure of confidence in the information regarding the object or feature;
use the received measure of confidence in the information regarding the object or feature to generate safety and confidence information regarding the object or feature suitable for use by vehicle autonomous and semi-autonomous driving systems in autonomous or semi-autonomous driving operations, wherein the safety and confidence information comprises one or more of an Automotive Safety Integrity Level (ASIL) autonomous driving level in the vicinity of the object or feature; an indication related to accuracy of the map data regarding the object or feature; a statistical score indicative of a precision of the map data regarding the object or feature; an indication related to reliability of the map data regarding the object or feature; or an age or freshness of the map data regarding the object or feature; and
store or update the safety and confidence information regarding the object or feature in a manner that enables access by vehicle autonomous and semi-autonomous driving systems.

36. The computing device of claim 35, wherein the processor is further configured to receive from one or more vehicles information including: a location of the object or feature; a characteristic of the object or feature; and a measure of confidence in the information regarding either the location or the characteristic of the object or feature.

37. The computing device of claim 35, wherein the processor is further configured to store or update the safety and confidence information regarding the object or feature in a manner that enables access by vehicle autonomous and semi-autonomous driving systems by either:
storing the safety and confidence information as part of location and other information regarding the object or feature in the map database provided to vehicles for use in autonomous or semi-autonomous driving operations; or
storing the safety and confidence information in a database separate from the map database correlated with location information of the object or feature, and providing the database to vehicles for use in autonomous or semi-autonomous driving operations.

38. The computing device of claim 35, the processor is further configured to:
receive, from a plurality of sources, information regarding an object or feature for inclusion in a map database along with measures of confidence in the information regarding the object or feature;
determine, from information received from the plurality of sources, one set of information regarding the object or feature and consolidated safety and confidence information for the determined set of information regarding the object or feature; and
store or update the consolidated safety and confidence information for the determined set of information regarding the object or feature in a manner that enables access by vehicle autonomous and semi-autonomous driving systems for use in autonomous or semi-autonomous driving operations.
